(19) United States
(12) Patent Application Publication
(10) Pub. No.: US 2025/0168093 A1
(43) Pub. Date: May 22, 2025

(54) DELAYING REQUESTS FOR RESOURCES RELATED SMALL DATA TRANSMISSION

(71) Applicant: GOOGLE LLC, Mountain View, CA (US)

(72) Inventor: Chih-Hsiang Wu, Taoyuan City (TW)

(21) Appl. No.: 18/839,591

(22) PCT Filed: Feb. 22, 2023
(86) PCT No.: PCT/US23/13627

§ 371 Date: Aug. 19, 2024

Related U.S. Application Data
(60) Provisional application No. 63/312,778, filed on Feb. 22, 2022.
(60) Provisional application No. 63/312,787, filed on Feb. 22, 2022.

(51) Int. Cl. H04L 43/0852; H04W 28/02

(52) U.S. Cl. CPC H04L 43/0852; H04W 28/0278

(57) ABSTRACT

To transmit a control element (CE) to a radio access network (RAN) (105), a UE (102) determines, when performing a small data transmission (SDT) procedure, that a resource for transmitting the CE to the RAN (105) is not available (e.g., event (704)). In response to the determining and in accordance with a delay configuration, the UE (102) delays a transmission of a request for the resource to the RAN (105) (e.g., event (708)).

### FIELD OF THE DISCLOSURE

This disclosure relates generally to wireless communications and, more particularly, to communication of uplink and/or downlink data at a user equipment (UE) and a radio access network (RAN) when the UE operates in an inactive or idle state associated with a protocol for controlling radio resources.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating in a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE state to allow a UE to more quickly transition back to the RRC_CONNECTED state due to Radio Access Network (RAN)-level base station coordination and RAN-paging procedures. In some cases, the UE in the RRC_INACTIVE state has only one, relatively small packet to transmit. A Small Data Transmission (SDT) procedure can enable the a network to support data transmission for the UE operating in the RRC_INACTIVE state (i.e., without transitioning to RRC_CONNECTED state).

SDT is enabled on a radio bearer basis and is initiated by the UE only if less than a configured amount of uplink data awaits transmission across all radio bearers for which SDT is enabled, the downlink reference signal received power (RSRP) is above a configured threshold, and a valid SDT resource is available. An SDT procedure can be initiated by the UE with either a transmission over a random access channel (RACH) (i.e., called random access SDT (RA-SDT)) or over Type 1 configured grant (CG) resources (i.e., called CG-SDT). For the RA-SDT, the network configures two-step and/or four-step random access resources for SDT. In the RA-SDT, the UE can transmit an initial transmission including data in a message three (MSG3) of a four-step random access procedure or in payload of a message A (MSGA or MsgA) of a two-step random access procedure. The network can then schedule subsequent uplink and/or downlink transmissions using dynamic uplink grants and downlink assignments, respectively, after the completion of the random access procedure.

The CG-SDT (or the CG-SDT session) can only be initiated with valid UL timing alignment. The UL timing alignment is maintained by the UE based on a network configured SDT-specific timing alignment timer and DL RSRP of a configured number of highest ranked synchronization signal blocks (SSBs). Upon expiry of the SDT-specific timing alignment timer, the CG resources are released. Upon initiating the CG-SDT, the UE transmits an initial transmission, including data, on a CG occasion using a CG, and the network can schedule subsequent uplink transmissions using dynamic grants. Alternatively, the subsequent transmissions can take place on following CG resource occasions. During the CG-SDT, the downlink transmissions are scheduled using dynamic assignments. The UE can initiate subsequent uplink transmission only after reception of confirmation for the initial transmission from the network.

In some scenarios and implementations, the UE performs SDT with a base station (e.g., a 5G NR base station such as a gNB). When the UE has SDT data to transmit and has no UL resources scheduled by the base station, the UE transmits an SDT resource request (e.g., a random access preamble of a four-step random access procedure or a MsgA of a two-step random access procedure) to request the base station to schedule uplink resources for the UE. In some implementations, the base station may schedule uplink resources for the UE less frequently than non-SDT because data qualified for SDT (i.e., SDT data) is not urgent. In such cases, it is not desirable for the base station to receive an SDT resource request from a UE, or service this request by scheduling uplink resources for the UE. In other implementations, the base station provides a CG configuration for SDT to the UE and prefers to restrict the UE to only transmit SDT data on CG resources configured in the CG configuration. However, there is no mechanism for the base station to prevent the UE from sending an SDT resource request to the base station to request the base station to schedule uplink resources for the UE.

### SUMMARY

An example embodiment of the techniques of this disclosure is a method of transmitting a control element (CE) to a radio access network (RAN). The method is implemented in a user equipment (UE) and comprises determining, when the UE is performing a small data transmission (SDT) procedure, that a resource for transmitting the CE to the RAN is not available; and delaying, in response to the determining and in accordance with a delay configuration, a transmission of a request for the resource to the RAN.

Another example embodiment of these techniques is a method for configuring a user equipment (UE). The method is implemented in a radio access node (RAN) and includes generating a delay configuration according to which the UE is to delay requesting a resource for a transmission to the RAN, during a small data transmission (SDT) procedure; transmitting the delay configuration to the UE; and receiving, from the UE, the request for the resource in accordance with the delay configuration.

### BRIEF DESCRIPTION OF THE DRAWINGS

FIG. 1A is a block diagram of an example wireless communication system in which a user device and a base station of this disclosure can implement the techniques of this disclosure for reducing latency in data communication;

FIG. 1B is a block diagram of an example base station in which a centralized unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3 illustrates an example scenario in which a UE communicates in a connected state with a distributed base station using a non-SDT configuration until the base station determines to cause the UE to transition into an inactive state;

FIG. 4 illustrates an example scenario similar to FIG. 3, but in which the UE communicates with a distributed base station via UL resources while in an inactive state and remains in an inactive state;

FIG. 5A illustrates an example scenario in which the UE communicates with a distributed base station via small data transmission (SDT) before transmitting a non-SDT indication to the base station and entering a connected state;

FIG. 5B illustrates an example scenario similar to FIG. 5A, but in which the UE transmits a request to the distributed base station to resume a radio connection with the UE;

FIG. 6A illustrates an example method implemented at a base station for generating an SDT configuration, including a delay configuration, for a UE and transmitting the configuration to the UE;

FIG. 6B illustrates an example method similar to FIG. 6A, but in which the base station generates the SDT configuration including the delay configuration when the SDT is a CG-SDT;

FIG. 6C illustrates an example method similar to FIGS. 6A and 6B, but in which the base station generates an SDT configuration including the delay configuration when the base station determines to configure such a delay configuration;

FIG. 7 illustrates an example method implemented at a DU for generating a delay configuration for delaying an SDT resource request and transmitting the delay configuration to the CU and UE;

FIG. 8 illustrates an example method implemented at a DU for generating a first or second delay configuration based on whether a CU-to-DU message requests lower configurations for SDT;

FIG. 9 illustrates an example method implemented at a base station for transmitting a first and second delay configuration to a UE to delay an SDT and non-SDT resource request, respectively;

FIG. 10 illustrates an example method for determining whether to transmit a first or second delay configuration to a UE based on whether a request from the UE is for SDT or non-SDT operations, implemented in a base station;

FIG. 11 illustrates an example method for determining to configure and transmitting a configuration for a UE to delay requesting resources for SDT and non-SDT operations, implemented in a base station;

FIG. 12 illustrates an example method for transmitting a first and second plurality of configuration parameters to a UE and communicating with the UE according to the configuration parameters, implemented in a base station;

FIG. 13A illustrates an example method for determining whether to transmit a data packet to a RAN node during an SDT session or delay initiation of an SDT resource request based on whether a UE has uplink resources for transmitting data, implemented in a UE;

FIG. 13B illustrates an example method similar to FIG. 13A, but in which the UE further determines whether to delay or initiate an SDT resource request based on whether the UE is configured to delay an SDT resource request, implemented in a UE;

FIG. 14A illustrates an example method for determining whether to transmit a data packet or delay initiation of an SDT resource request based on whether the UE has uplink resources to transmit a MAC control element, implemented in a UE;

FIG. 14B illustrates an example method similar to FIG. 14A, but in which the UE further determines whether to delay or initiate an SDT resource request based on whether the UE is configured to delay an SDT resource request, implemented in a UE;

FIG. 15 illustrates an example method for receiving a delay configuration from a RAN node, applying the configuration while in an inactive state, and suspending application of the configuration while in a connected state, implemented in a UE;

FIG. 16 illustrates an example method for applying a delay configuration while in a connected state, performing SDT while in an inactive state, and either suspending application of the delay configuration or applying the delay configuration during SDT, implemented in a UE;

FIG. 17 illustrates an example method for determining whether to apply a delay configuration while in a connected or inactive state based on whether the delay configuration is applicable for a connected or inactive state, implemented in a UE; and

FIG. 18 illustrates an example method for receiving a first and second plurality of configuration parameters and using the configuration parameters to communicate with a RAN node, implemented in a UE.

### DETAILED DESCRIPTION OF THE DRAWINGS

As discussed in more detail below, a user equipment (UE) and/or a network node of a radio access network (RAN) can use the techniques of this disclosure for managing small or early data communication and transitioning a UE between states of a protocol for controlling radio resources between the UE and the RAN. As used in this disclosure, early data communication can refer to early data transmission (EDT) or small data transmission (SDT) from the perspective of the network (i.e., EDT or SDT in the downlink direction), or EDT or SDT from the perspective of the UE (i.e., EDT or SDT in the uplink direction).

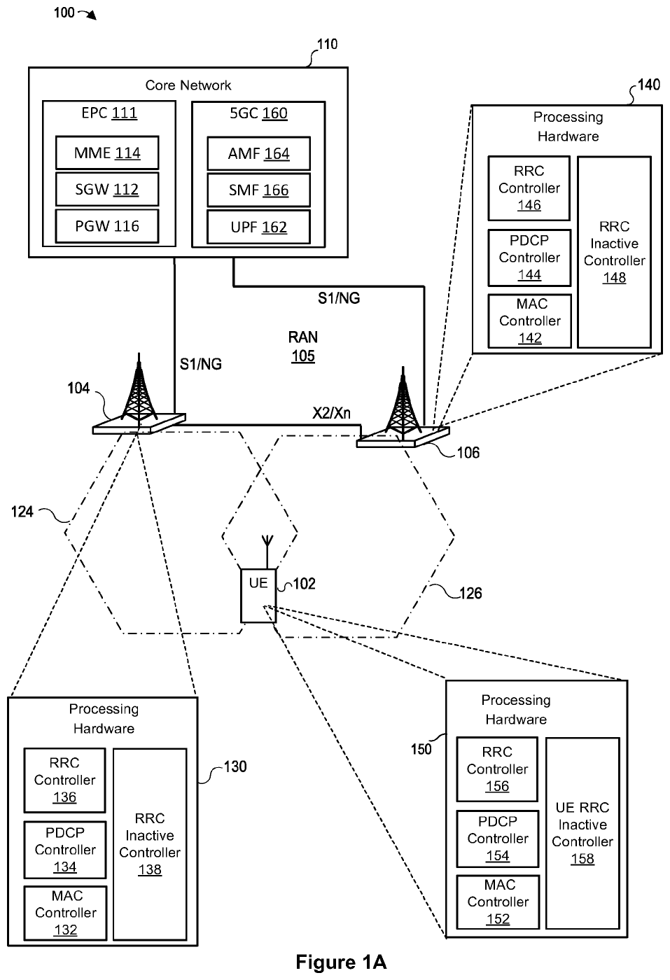

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 covers a cell 124, and the base station 106 covers a cell 126. If the base station 104 is a gNB, the cell 124 is an NR cell. If the base station 104 is an ng-eNB, the cell 124 is an evolved universal terrestrial radio access (E-UTRA) cell. Similarly, if the base station 106 is a gNB, the cell 126 is an NR cell, and if the base station 106 is an ng-eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

As discussed in detail below, the UE 102 and/or the RAN 105 may utilize the techniques of this disclosure when the radio connection between the UE 102 and the RAN 105 is suspended, e.g., when the UE 102 operates in an inactive or idle state of the protocol for controlling radio resources between the UE 102 and the RAN 105. For clarity, the examples below refer to the RRC_INACTIVE or RRC_IDLE state of the RRC protocol.

As used in this disclosure, the term “data” or “data packet” refers to signaling, control-plane information at a protocol layer of controlling radio resources (e.g., RRC); controlling mobility management (MM); controlling session management (SM); or non-signaling, non-control-plane information at protocol layers above the layer of the protocol for controlling radio resources (e.g., RRC), above the layer of the protocol for controlling mobility management (MM), above the layer of the protocol for controlling session management (SM), or above the layer of the protocol for controlling quality of service (QOS) flows (e.g., service data adaptation protocol (SDAP)). The data to which the UE and/or the RAN applies the techniques of this disclosure can include, for example, Internet of Things (IoT) data, ethernet traffic data, internet traffic data, or a short message service (SMS) message. Further, as discussed below, the UE 102 in some implementations applies these techniques only if the size of the data is below a certain threshold value.

In the example scenarios discussed below, the UE 102 transitions to the RRC_INACTIVE or RRC_IDLE state, selects a cell of the base station 104, and exchanges data with the base station 104, either via the base station 106 or with the base station 104 directly, without transitioning to RRC_CONNECTED state. As a more specific example, after the UE 102 determines that data is available for uplink transmission in the RRC_INACTIVE or RRC_IDLE state, the UE 102 can apply one or more security functions to an uplink (UL) data packet, generate a first UL protocol data unit (PDU) including the security-protected packet, include a UL RRC message along with the first UL PDU in a second UL PDU, and transmit the second UL PDU to the RAN 105. The UE 102 includes a UE identity/identifier (ID) for the UE 102 in the UL RRC message. The RAN 105 can identify the UE 102 based on the UE ID. In some implementations, the UE ID can be an inactive Radio Network Temporary Identifier (I-RNTI), a resume ID, or a non-access stratum (NAS) ID. The NAS ID can be an S-Temporary Mobile Subscriber Identity (S-TMSI) or a Global Unique Temporary Identifier (GUTI).

The security function can include an integrity protection and/or encryption function. When integrity protection is enabled, the UE 102 can generate a message authentication code for integrity (MAC-I) to protect integrity of the data. Thus, the UE 102 in this case generates a security-protected packet including the data and the MAC-I. When encryption is enabled, the UE 102 can encrypt the data to obtain an encrypted packet, so that the security-protected packet includes encrypted data. When both integrity protection and encryption are enabled, the UE 102 can generate a MAC-I for protecting integrity of the data and encrypt the data along with the MAC-I to generate an encrypted packet and an encrypted MAC-I. The UE 102 then can transmit the security-protected packet to the RAN 105 while in the RRC_INACTIVE or RRC_IDLE state.

In some implementations, the data is an uplink (UL) service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU such as a UL MAC PDU, which can be associated with the medium access control (MAC) layer. Thus, the UE 102 in these cases transmits the secured UL PDCP PDU in the UL MAC PDU. In some implementations, the UE 102 can include, in the UL MAC PDU, a UL RRC message. In further implementations, the UE 102 may not include a UL RRC message in the UL MAC PDU. In this case, the UE 102 may not include a UE ID of the UE 102 in the UL MAC PDU not including a UL RRC message. In yet further implementations, the UE 102 can include the UL PDCP PDU in a UL radio link control (RLC) PDU and then include the UL RLC PDU in the UL MAC PDU. In the case of including the UL RRC message in the UL MAC PDU, the UE 102 in some implementations generates an RRC MAC-I and includes the RRC MAC-I in the UL RRC message. For example, the RRC MAC-I is a resumeMAC-I field, as specified in 3GPP specification 38.331. In further implementations, the UE can obtain the RRC MAC-I from the UL RRC message with an integrity key (e.g., KRRCint key), an integrity protection algorithm, and other parameters COUNT (e.g., 32-bit, 64-bit or 128-bit value), BEARER (e.g., 5-bit value) and DIRECTION (e.g., 1-bit value).

In further implementations, the data is a UL service data unit (SDU) of the NAS. The UE 102 applies the security function to the SDU and includes the secured SDU in a first UL PDU such as a NAS PDU, which can be associated with the NAS layer. For example, the NAS layer can be an MM sublayer or SM sublayer of 5G, Evolved Packet System (EPS), or 6G. Then the UE 102 can include the UL NAS PDU in a second UL PDU such as a UL RRC message. Thus, the UE 102 in these cases transmits the (first) secured UL NAS PDU in the UL RRC message. In some implementations, the UE 102 can include the UL RRC message in a UL MAC PDU and transmits the UL MAC PDU to a base station (e.g., base station 104 or 106) via a cell (e.g., cell 124 or 126). In this case, the UE 102 may not include an RRC MAC-I in the UL RRC message. Alternatively, the UE 102 may include an RRC MAC-I as described above.

In some implementations, the UL RRC message described above can be a common control channel (CCCH) message, an RRC resume request message, or an RRC early data request message. The UL RRC message can include a UE ID of the UE 102 as described above.

More generally, the UE 102 can secure the data using at least one of encryption and integrity protection, include the secured data as a security-protected packet in the first UL PDU, and transmit the first UL PDU to the RAN 105 in the second UL PDU.

In some scenarios and implementations, the base station 106 can retrieve the UE ID of the UE 102 from the UL RRC message and identify the base station 104 as the destination of the data in the first UL PDU, based on the determined UE ID. In one example implementation, the base station 106 retrieves the first UL PDU from the second UL PDU and transmits the first UL PDU to the base station 104. The base station 104 then retrieves the security-protected packet from the first UL PDU, applies one or two security functions to decrypt the data and/or check the integrity protection, and transmits the data to the CN 110 (e.g., SGW 112, UPF 162, MME 114 or AMF 164) or an edge server. In some implementations, the edge server can operate within the RAN 105. More specifically, the base station 104 derives at least one security key from UE context information of the UE 102. Then the base station 104 retrieves the data from the security-protected packet by using the at least one security key and transmits the data to the CN 110 or edge server. When the security-protected packet is an encrypted packet, the base station 104 decrypts the encrypted packet to obtain the data by using the at least one security key (e.g., an encryption and/or decryption key). If the security-protected packet is an integrity-protected packet, the integrity-protected packet may include the data and the MAC-I. The base station 104 can verify whether the MAC-I is valid for the security-protected packet by using the at least one security key (e.g., an integrity key). When the base station 104 confirms that the MAC-I is valid, the base station 104 sends the data to the CN 110 or edge server. However, when the base station 104 determines that the MAC-I is invalid, the base station 104 discards the security-protected packet. Further, if the security-protected packet is both encrypted and integrity-protected, the encrypted and integrity-protected packet may include the encrypted packet along with the encrypted MAC-I. The base station 104 in this case decrypts the encrypted packet and the encrypted MAC-I to obtain the data and the MAC-I. The base station 104 then determines whether the MAC-I is valid for the data. If the base station 104 determines that the MAC-I is valid, the base station 104 retrieves the data and forwards the data to the CN 110 or edge server. However, if the base station 104 determines that the MAC-I is invalid, the base station 104 discards the packet.

In another implementation, the base station 106 retrieves the security-protected packet from the first UL PDU. The base station 106 performs a retrieve UE context procedure with the base station 104 to obtain UE context information of the UE 102 from the base station 104. The base station 106 derives at least one security key from the UE context information. Then the base station 106 retrieves the data from the security-protected packet by using the at least one security key and transmits the data to the CN 110 (e.g., UPF 162) or an edge server. When the security-protected packet is an encrypted packet, the base station 106 decrypts the encrypted packet to obtain the data by using the at least one security key (e.g., an encryption and/or decryption key). If the security-protected packet is an integrity-protected packet, the integrity protected packet may include the data and the MAC-I. The base station 106 can verify whether the MAC-I is valid for the security-protected packet by using the at least one security key (e.g., an integrity key). When the base station 106 confirms that the MAC-I is valid, the base station 106 sends the data to the CN 110. On the other hand, when the base station 106 determines that the MAC-I is invalid, the base station 106 discards the security-protected packet. Further, if the security-protected packet is both encrypted and integrity-protected, the encrypted and integrity-protected packet may include the encrypted packet along with the encrypted MAC-I. The base station 106 in this case decrypts the encrypted packet and the encrypted MAC-I to obtain the data and the MAC-I. The base station 106 then determines whether the MAC-I is valid for the data. If the base station 106 determines that the MAC-I is valid, the base station 106 retrieves the data and forwards the data to the CN 110. However, if the base station 106 determines that the MAC-I is invalid, the base station 106 discards the packet.

In other scenarios and implementations, the base station 104 can retrieve the UE ID of the UE 102 from the UL RRC message and identify that the base station 104 stores UE context information of the UE 102. Thus, the base station 104 retrieves the security-protected packet from the first UL PDU, retrieves the data from the security-protected packet, and sends the data to the CN 110 or edge server as described above.

Further, the RAN 105 in some cases transmits data in the downlink (DL) direction to the UE 102 operating in the RRC_INACTIVE or RRC_IDLE state.

For example, when the base station 104 determines that data is available for downlink transmission to the UE 102 currently operating in the RRC_INACTIVE or RRC_IDLE state, the base station 104 can apply at least one security function to the data to generate a security-protected packet, generate a first DL PDU including the security-protected packet, and the first DL PDU in a second DL PDU. To secure the data, the base station 104 can apply the security function (e.g., integrity protection and/or encryption) to the data. More particularly, when integrity protection is enabled, the base station 104 generates a MAC-I for protecting integrity of the data, so that the security-protected packet includes the data and the MAC-I. When encryption is enabled, the base station 104 encrypts the data to generate an encrypted packet, so that the security-protected packet is an encrypted packet. Further, when both integrity protection and encryption are enabled, the base station 104 can generate a MAC-I for protecting the integrity of the data and encrypt the data along with the MAC-I to generate an encrypted packet and an encrypted MAC-I. The base station 104 in some implementations generates a first DL PDU, such as a DL PDCP PDU, using the security-protected packet, includes the first DL PDU in a second DL PDU associated with the MAC layer for example (e.g., a DL MAC PDU), and transmits the second DL PDU to the UE 102 without first causing the UE 102 to transition from the RRC_INACTIVE or RRC_IDLE state to the RRC_CONNECTED state. In some implementations, the base station 104 includes the DL PDCP PDU in a DL RLC PDU, includes the DL RLC PDU in the DL MAC PDU and transmits the DL MAC PDU to the UE 102 without first causing the UE 102 to transition from the RRC_INACTIVE or RRC_IDLE state to the RRC_CONNECTED state.

In another implementation, the base station 104 transmits the first DL PDU to the base station 106, which then generates a second PDU (e.g., a DL MAC PDU) including the first DL PDU and transmits the second DL PDU to the UE 102 without first causing the UE 102 to transition from the RRC_INACTIVE or RRC_IDLE state to the RRC_CONNECTED state. In some implementations, the base station 106 generates a DL RLC PDU including the first DL PDU and includes the DL RLC PDU in the second DL PDU. In yet another implementation, the base station 104 includes the first DL PDU in a DL RLC PDU and transmits the DL RLC PDU to the base station 106, which then generates a second DL PDU (e.g., a DL MAC PDU), including the DL RLC PDU, and transmits the second DL PDU to the UE 102.

In some implementations, the base station (i.e., the base station 104 or 106) generates a downlink control information (DCI) and a cyclic redundancy check (CRC) scrambled with an ID of the UE 102 to transmit the second DL PDU generated by the base station. In some implementations, the ID of the UE 102 can be a Radio Network Temporary Identifier (RNTI). For example, the RNTI can be a cell RNTI (C-RNTI), a temporary C-RNTI or an inactive C-RNTI. The base station transmits the DCI and scrambled CRC on a physical downlink control channel (PDCCH) to the UE 102 operating in the RRC_INACTIVE or RRC_IDLE state. The base station scrambles the CRC with the ID of the UE 102. In some implementations, the base station may assign the ID of the UE 102 to the UE 102 in a random access response or a message B (MsgB) that the base station transmits in a random access procedure with the UE 102 before transmitting the DCI and scrambled CRC. In further implementations, the base station may assign the ID of the UE 102 to the UE 102 in an RRC message (e.g., RRC release message or an RRC reconfiguration message) that the base station transmits to the UE 102 before transmitting the DCI and scrambled CRC, e.g., while the UE 102 was in the RRC_CONNECTED state.

The UE 102 operating in the RRC_INACTIVE or RRC_IDLE state can receive the DCI and scrambled CRC on the PDCCH. Then the UE 102 confirms that a physical downlink shared channel (PDSCH), including the second DL PDU, is addressed to the UE 102 according to the ID of the UE 102, DCI, and scrambled CRC. The UE 102 then can retrieve the data from the security-protected packet. If the security-protected packet is an encrypted packet, the UE 102 can decrypt the encrypted packet using the appropriate decryption function and the security key to obtain the data. If the security-protected packet is the integrity-protected packet including the data and the MAC-I, the UE 102 can determine whether the MAC-I is valid. If the UE 102 confirms that the MAC-I is valid, the UE 102 retrieves the data. If, however, the UE 102 determines that the MAC-I is invalid, the UE 102 discards the packet. Finally, when the security-protected packet is both encrypted and integrity-protected, with encrypted data and an encrypted MAC-I, the UE 102 can decrypt the encrypted packet and encrypted MAC-I to obtain the data and the MAC-I. The UE 102 can then verify that the MAC-I is valid for the data. If the UE 102 confirms that the MAC-I is valid, the UE 102 retrieves and processes the data. Otherwise, when the UE 102 determines that the MAC-I is invalid, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Medium Access Control (MAC) controller 132 configured to perform a random access procedure with one or more user devices, receive uplink MAC protocol data units (PDUs) to one or more user devices, and transmit downlink MAC PDUs to one or more user devices. The processing hardware 130 can also include a Packet Data Convergence Protocol (PDCP) controller 134 configured to transmit DL PDCP PDUs in accordance with which the base station 104 can transmit data in the downlink direction, in some scenarios, and receive UL PDCP PDUs in accordance with which the base station 104 can receive data in the uplink direction, in other scenarios. The processing hardware further can include an RRC controller 136 to implement procedures and messaging at the RRC sublayer of the protocol communication stack. The processing hardware 130 in an example implementation includes an RRC inactive controller 138 configured to manage uplink and/or downlink communications with one or more UEs operating in the RRC_INACTIVE or RRC_IDLE state. The base station 106 can include generally similar components. In particular, components 140, 142, 144, 146, and 148 of the base station 106 can be similar to the components 130, 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage uplink and/or downlink communications when the UE 102 operates in the RRC_INACTIVE state. The processing hardware 150 in an example implementation includes a Medium Access Control (MAC) controller 152 configured to perform a random access procedure with a base station, transmit uplink MAC protocol data units (PDUs) to the base station, and receive downlink MAC PDUs from the base station. The processing hardware 150 can also include a PDCP controller 154 configured to, in some scenarios, transmit DL PDCP PDUs in accordance with which the base station 106 can transmit data in the downlink direction, and, in further scenarios, receive UL PDCP PDUs in accordance with which the base station 106 can receive data in the uplink direction. The processing hardware further can include an RRC controller 156 to implement procedures and messaging at the RRC sublayer of the protocol communication stack.

FIG. 1B depicts an example distributed or disaggregated implementation of any one or more of the base stations 104, 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller such as PDCP controller 134, 144, RRC controller 136, 146 and/or RRC inactive controller 138, 148. In some implementations, the CU 172 can include a radio link control (RLC) controller configured to manage or control one or more RLC operations or procedures. In further implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some embodiments, the RAN 105 supports Integrated Access and Backhaul (IAB) functionality. In some implementations, the DU 174 operates as an (IAB)-node, and the CU 172 operates as an IAB-donor.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can connect to multiple CU-CP 172A through the E1 interface. The CU-CP 172A can connect to one or more DU 174s through an F1-C interface. The CU-UP 172B can connect to one or more DU 174 through the F1-U interface under the control of the same CU-CP 172A. In some implementations, one DU 174 can connect to multiple CU-UP 172B under the control of the same CU-CP 172A. In such implementations, the connectivity between a CU-UP 172B and a DU 174 is established by the CU-CP 172A using Bearer Context Management functions.

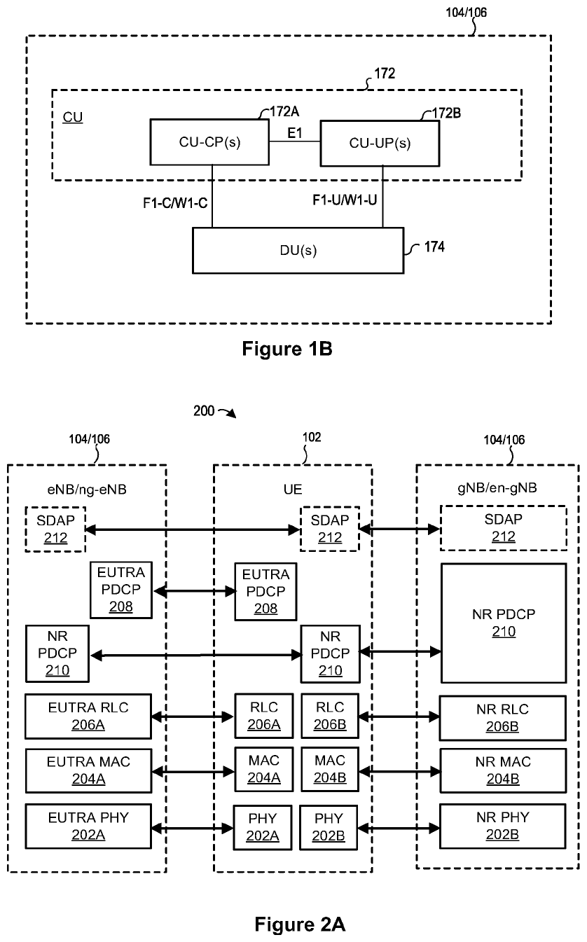

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide Data Radio Bearers (DRBs) to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250, which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

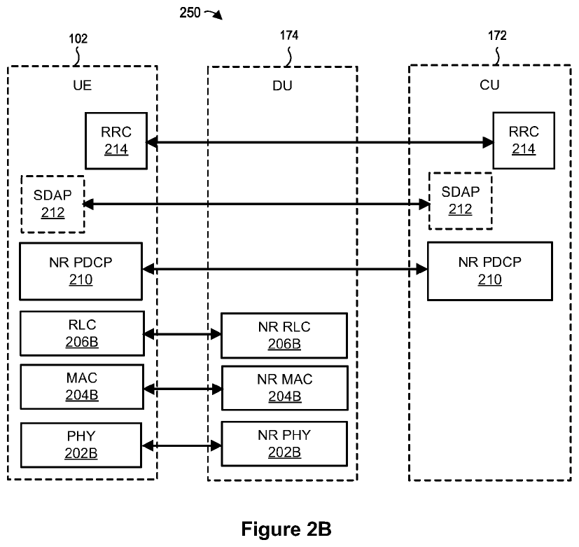

Next, several example scenarios that involve several components of FIG. 1A and relate to transmitting data in an inactive or idle state are discussed next with reference to FIGS. 3-5B. To simplify the following description, the “inactive state” is used and can represent the RRC_INACTIVE or RRC_IDLE state, and the “connected state” is used and can represent the RRC_CONNECTED state.

Referring first to FIG. 3, which illustrates a scenario 300, in which the base station 104 includes a central unit (CU) 172 and a distributed unit (DU) 174 and the CU 172 includes a CU-CP 172A and a CU-UP 172B. In this scenario, the UE 102 initially operates in a connected state 302 and communicates 304 with the DU 174, e.g., by using a DU configuration (i.e., a first non-SDT DU configuration), and communicates 304 with the CU-CP 172A and/or CU-UP 172B via the DU by using a CU configuration (i.e., a first non-SDT CU configuration). While the UE communicates 304 with the base station 104, the CU-CP 172A can send 306 a UE Context Modification Request message to the DU 174. In response, the DU 174 sends 308 a UE Context Modification Response message including a non-SDT configuration (i.e., a second non-SDT configuration) for the UE 102 to the CU-CP 172A. The CU-CP 172A generates an RRC reconfiguration message including the non-SDT DU configuration and transmits 310 a first CU-to-DU message (e.g., DL RRC Message Transfer message), including the RRC reconfiguration message, to the DU 174. In turn, the DU 174 transmits 312 the RRC reconfiguration message to the UE 102. In response, the UE 102 transmits 314 an RRC reconfiguration complete message to the DU 174, which in turn transmits 316 a first DU-to-CU message (e.g., UL RRC Message Transfer message), including the RRC reconfiguration complete message, to the CU-CP 172A.

After receiving 312 the RRC reconfiguration message, the UE 102 in the connected state communicates 318 with the DU 174 using the non-SDT DU configuration and communicates with the CU-CP 172A and/or CU-UP 172B via the DU 174. In cases where the RRC reconfiguration message does not include a CU configuration, the UE 102 communicates 318 with the CU-CP 172A and/or CU-UP 172B via the DU 174 using the first non-SDT CU configuration. In cases where the RRC reconfiguration message includes a non-SDT CU configuration (i.e., a second non-SDT CU configuration), the UE 102 communicates 318 with the CU-CP 172A and/or CU-UP 172B via the DU 174, using the second non-SDT CU configuration. In some implementations, the second non-SDT CU configuration augments the first non-SDT CU configuration or includes at least one new configuration parameter not included in the first non-SDT CU configuration. In some such cases, the UE 102 and the CU-CP 172A and/or the CU-UP 172B communicate 318 with one another using the second non-SDU CU configuration and configuration parameters in the first non-SDT CU configuration not augmented by the second non-SDU CU configuration.

In some implementations, the first non-SDT CU configuration includes configuration parameters related to operations of RRC and/or PDCP protocol layers (e.g., RRC 214 and/or NR PDCP 210) that the UE 102 and CU 172 use to communicate with one another while the UE 102 operates in the connected state. Similarly, in some implementations, the second non-SDT CU configuration includes configuration parameters related to operations of the RRC and/or PDCP protocol layers that the UE 102 and CU 172 use to communicate with one another while the UE 102 operates in the connected state. In some implementations, the first non-SDT CU configuration includes configuration parameters in a RadioBearerConfig information element (IE) and/or MeasConfig IE (e.g., as defined in 3GPP specification 38.331 v16.7.0). Similarly, the second non-SDT CU configuration includes configuration parameters in the RadioBearerConfig IE and/or MeasConfig IE. In some implementations, the first non-SDT CU configuration can be or include a RadioBearerConfig IE and/or a MeasConfig IE, and the second non-SDT CU configuration can be or include a RadioBearerConfig IE and/or MeasConfig IE.

In some implementations, the second non-SDT DU configuration augments the first non-SDT DU configuration or includes at least one new configuration parameter not included in the first non-SDT DU configuration. In some such cases, the UE 102 and the DU 174 communicate 318 with one another using the second non-SDU DU configuration and configuration parameters in the first non-SDT DU configuration not augmented by the second non-SDU DU configuration. In some implementations, the first non-SDT DU configuration includes configuration parameters related to operations of RRC, RLC, MAC, and/or PHY protocol layers (e.g., RLC 206B, MAC 204B and/or PHY 202B) that the UE 102 and DU 174 use to communicate with one another while the UE 102 operates in the connected state. Similarly, in some implementations, the second non-SDT DU configuration includes configuration parameters related to operations of the RRC, RLC, MAC, and/or PHY protocol layers that the UE 102 and DU 174 use to communicate with one another while the UE 102 operates in the connected state. In some implementations, the first non-SDT DU configuration includes configuration parameters in a CellGroupConfig IE (e.g., as defined in 3GPP specification 38.331 v16.7.0). Similarly, the second non-SDT DU configuration includes configuration parameters in the CellGroupConfig IE. In some implementations, the first non-SDT DU configuration and the second non-SDT DU configuration are CellGroupConfig IEs.

The events 306, 308, 310, 312, 314, 316 and 318 are collectively referred to in FIG. 3 as a non-SDT resource (re) configuration procedure 390, which can be optional.

While the UE 102 communicates with the base station 104 or after the non-SDT resource (re) configuration procedure 390 (if performed), the CU-CP 172A can determine to cause the UE 102 to transition to an inactive state from the connected state based on data inactivity of the UE 102 (i.e., the UE 102 in the connected state has no data activity with the base station 104). In some implementations, while the UE 102 communicates with the base station 104 or after the non-SDT resource (re) configuration procedure 390 (if performed), the UE 102 determines or detects data inactivity and transmits 320, to the DU 174, UE assistance information (e.g., a UEAssistanceInformation message) indicating that the UE 102 prefers or requests to transition to the inactive state with SDT configured. In turn, the DU 174 transmits 321 a UL RRC Message Transfer message, including the UE assistance information, to the CU-CP 172A. Thus, the CU-CP 172A can determine that the UE 102 is in a state of data inactivity based on the UE assistance information. In other implementations, the DU 174 can perform data inactivity monitoring for the UE 102. The CU-CP 172A can transmit a CU-to-DU message (e.g., a UE Context Setup Request message or a UE Context Modification Request message) to the DU 174 to request or command the DU 174 to perform the data inactivity monitoring. In cases where the DU 174 detects or determines that the UE 102 is in a state of data inactivity during the monitoring, the DU 174 can transmit 322 an inactivity notification (e.g., UE Inactivity Notification message) to the CU-CP 172A. Thus, the CU-CP 172A can determine that the UE 102 is in a state of data inactivity based on the inactivity notification received from the DU 174.

In yet other implementations, the CU-UP 172B can perform data inactivity monitoring for the UE 102. The CU-CP 172A can transmit a CP-to-UP message (e.g., a Bearer Context Setup Request message or a Bearer Context Modification Request message) to the CU-UP 172B to request or command the CU-UP 172B to perform the data inactivity monitoring. In cases where the CU-UP 172B detects or determines that the UE 102 is in a state of data inactivity during the monitoring, the CU-UP 172B can transmit 323 an inactivity notification (e.g., Bearer Context Inactivity Notification message) to the CU-CP 172A. Thus, the CU-CP 172A can determine that the UE 102 is in a state of data inactivity based on the inactivity notification received from the CU-UP 172B. In some implementations, the CU-CP 172A can determine that the UE 102 is in a state of data inactivity based on the UE assistance information, inactivity notification of the event 322 and/or inactivity notification of the event 323.

After a certain period of data inactivity, the CU-CP 172A can determine that neither the CU 172 (i.e., the CU-CP 172A and/or the CU-UP 172B) nor the UE 102 has transmitted any data in the downlink direction or the uplink direction, respectively, during the certain period. In response to the determination, the CU-CP 172A can determine to cause the UE 102 to transition to the inactive state with SDT configured. Alternatively, the CU-CP 172A can determine to cause the UE 102 to transition to the inactive state without SDT configured in response to determining that the UE 102 is in a state of data inactivity.

In response to or after determining that the UE 102 is in a state of data inactivity (for the certain period) or determining to cause the UE 102 to transition to the inactive state with SDT configured, the CU-CP 172A sends 324 to the CU-UP 172B a Bearer Context Modification Request message to suspend data transmission for the UE 102. In response, the CU-UP 172B suspends data transmission for the UE 102 and sends 326 a Bearer Context Modification Response message to the CU-CP 172A. In response to or after determining that the UE 102 is in a state of data inactivity (for the certain period) or determining to cause the UE 102 to transition to the inactive state with SDT configured, the CU-CP 172A in some implementations can send 328 a second CU-to-DU message (e.g., a UE Context Modification Request message) to instruct the DU 174 to provide an SDT DU configuration for the UE 102. In some implementations, the CU-CP 172A can include an SDT request indication (e.g., an IE such as a CG-SDT Query Indication IE) to request an SDT DU configuration in the second CU-to-DU message. In response to the SDT request indication or the second CU-to-DU message, the DU 174 can transmit 330 a second DU-to-CU message (e.g., UE Context Modification Response message) to the CU-CP 172A. Alternatively, the DU 174 does not include the SDT DU configuration in the second DU-to-CU message. Instead, the DU 174 sends to the CU-CP 172A an additional DU-to-CU message (e.g., UE Context Modification Required message) including the SDT DU configuration, after receiving the second CU-to-DU message or transmitting the second DU-to-CU message. The CU-CP 172A can transmit an additional CU-to-DU message (e.g., UE Context Modification Confirm message) to the DU 174 in response to the additional CU-to-DU message. In some alternative implementations, the CU-CP 172A can transmit the second CU-to-DU message and receive the second DU-to-CU message or the additional DU-to-CU message, before determining that the UE 102 is in a state of data inactivity. In further implementations, the CU-CP 172A can include the SDT request indication in the first CU-to-DU message of the event 308 and the DU 174 includes the SDT DU configuration in the first DU-to-CU message of the event 310 in response to the SDT request indication.

In response to determining to cause the UE 102 to transition to the inactive state with SDT configured, the CU-CP 172A can generate an RRC release message (e.g., RRCRelease message RRCConnectionRelease message) to cause the UE 102 to transition to the inactive state. The CU-CP 172A can include the SDT DU configuration (if obtained from the DU 174) and/or an SDT CU configuration in the RRC release message. The CU-CP 172A then sends 332 to the DU 174 a third CU-to-DU message (e.g., a UE Context Release Command message, a UE Context Modification Request message or a DL RRC Message Transfer message) which includes the RRC release message. In turn, the DU 174 transmits 334 the RRC release message to the UE 102. In some implementations, the DU 174 generates a MAC PDU including the RRC release message and transmits 334 the MAC PDU to the UE 102. The RRC release message instructs the UE 102 to transition to the inactive state. The UE 102 transitions 336 to the inactive state from the connected state upon receiving the RRC release message. In response to the third CU-to-DU message, the DU 174 can retain the SDT DU configuration (if generated by the DU 174 during the procedure 328, 330) and can release or retain (a portion of) the first non-SDT DU configuration and/or (a portion of) second non-SDT DU configuration. The DU 174 can send a third DU-to-CU message (e.g., a UE Context Release Complete message or a UE Context Modification Response message) to the CU-CP 172A in response to the third CU-to-DU message.

In some implementations, the UE 102 monitors a PDCCH using a C-RNTI to receive a DCI while operating 302 in the connected state. In response to or after receiving 334 the RRC release message, the UE 102 stops using the C-RNTI to monitor a PDCCH. In some implementations, the UE 102 may retain the C-RNTI in response to or after receiving 334 the RRC release message or transitioning 336 to the inactive state from the connected state. In some implementations, the UE 102 performs a two-step or a four-step random access procedure with the base station 104 (e.g., the CU-CP 172A and/or DU 174) and receives from the DU 174 a random access response message including the C-RNTI in the random access procedure. In other implementations, the UE 102 receives an RRC message (e.g., RRC reconfiguration message), including the C-RNTI, from the CU-CP 172A via the DU 174 or another base station (e.g., base station 106) not shown in FIG. 3.

The events 320 (optional), 321 (optional), 322 (optional), 323, 324, 326, 328, 330, 332 and 334 are collectively referred to in FIG. 3 as an SDT configuration procedure 394.

In some implementations, the UE 102 releases the first non-SDT DU configuration and/or second non-SDT DU configuration, or at least a portion of the first non-SDT DU configuration and at least a portion of the second non-SDT DU configuration in response to the RRC release message. In other implementations, if the RRC release message instructs the UE 102 to transition to the inactive state (i.e., RRC_IDLE), the UE 102 releases the first non-SDT DU configuration and/or second non-SDT configuration. In yet other implementations, if the RRC release message instructs the UE 102 to transition to the inactive state (i.e., RRC_INACTIVE), the UE 102 releases a first portion of the first and/or second non-SDT DU configurations and retains a second portion of the first and/or second non-SDT DU configurations.

In some implementations, the CU-CP 172A does not include an indication in the third CU-to-DU message to instruct the DU 174 to retain the SDT DU configuration. The DU 174 retains the SDT DU configuration as described above. In other implementations, the CU-CP 172A can include an indication in the third CU-to-DU message (e.g., a UE Context Release Command message) to instruct the DU 174 to retain the SDT DU configuration, and the DU 174 retains the SDT DU configuration in response to the indication. If the UE Context Release Command message excludes the indication, the DU 174 releases the SDT DU configuration. In yet other implementations, the CU-CP 172A does not include an indication in the third CU-to-DU message (e.g., a UE Context Modification Request message or a DL RRC Message Transfer message) for the UE 102 to instruct the DU 174 to release the SDT DU configuration. Thus, the DU 174 retains the SDT DU configuration in response to the third CU-to-DU message excluding the indication. If the third CU-to-DU message includes the indication, the DU 174 releases the SDT DU configuration.

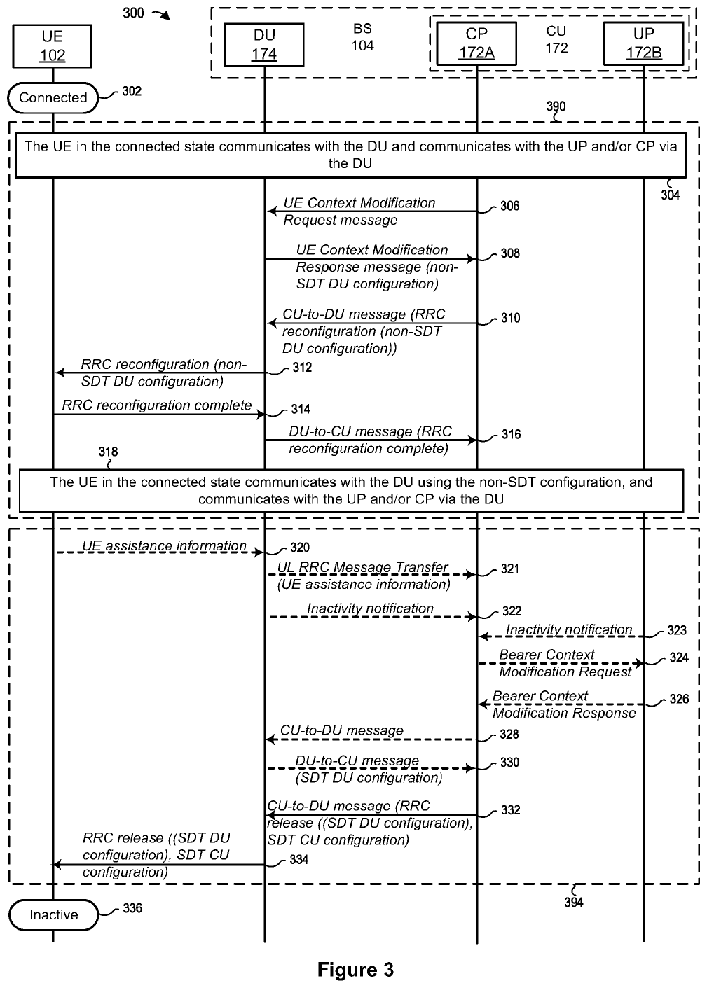

In some implementations, the SDT CU configuration (e.g., SDT-Config IE) includes a DRB list (e.g., a std-DRB-List) including a list of DRB ID(s) indicating ID(s) of DRB(s) configured for SDT. In some implementations, the SDT CU configuration includes an SRB2 indication (e.g., sdt-SRB2-Indication) indicating an SRB2 configured for SDT. In some implementations, the SDT CU configuration includes a compression protocol continue indication (e.g., sdt-DRB-ContinueROHC) indicating whether a PDCP entity for the DRB(s) configured for SDT, during SDT operation (i.e., initial and/or subsequent SDT described for FIG. 4), continues. For example, the compression protocol can be a Robust Header Compression (ROHC). In some implementations, the SDT CU configuration includes a data volume threshold (e.g., sdt-DataVolumeThreshold) for the UE 102 to determine whether the UE 102 can initiate SDT. In further implementations, the CU-CP 172A includes the SDT DU configuration in the SDT CU configuration. In some implementations, the “SDT CU configuration” may be simplified to “SDT configuration”.

In some implementations, the SDT DU configuration includes at least one of a buffer status reporting (BSR) configuration, a power headroom reporting (PHR) configuration, configured grant (CG) configuration(s) for CG-SDT, a UL bandwidth part (BWP) configuration, a DL BWP configuration for CG-SDT, a time alignment timer value for CG-SDT (e.g., CG-SDT time alignment timer (CG-SDT-TAT) value), and/or a timing advance validity threshold for CG-SDT. In some implementations, the UL BWP configuration configures a dedicated UL BWP for the UE 102 to perform CG-SDT. The UL BWP configuration can include the CG configuration(s), a physical uplink control channel (PUCCH) configuration, a physical uplink shared channel (PUSCH) configuration, and/or a sounding reference signal (SRS) configuration. In some implementations, the DL BWP configuration configures a dedicated DL BWP for the UE 102 during CG-SDT. In some implementations, the DL BWP configuration includes a PDCCH configuration and/or a PDSCH configuration for the UE 102 to receive DL control signals on PDCCH(s) and data on PDSCH(s) from the DU 174 while the UE 102 performs CG-SDT with the DU 174.

Each of the CG configuration(s) configures periodic radio resources (e.g., CG resources) that the UE 102 can use to transmit data without receiving a dynamic grant for data transmission. Each of the CG configuration(s) configures or includes a periodicity indicating that CG resources periodically occur. In some implementations, the periodicity can be a fixed number of symbols, slots or subframes. Some or all of the CG configuration(s) can have the same periodicity or different periodicities. In some implementations, each of the CG configuration(s) configures or includes an offset indicating a time domain offset (e.g., timeDomainOffset) related to a reference time (e.g., system frame number (SFN)) for the CG resources. In some implementations, the CG configuration configures or includes the reference time (e.g., timeReferenceSFN). In some implementations, the CG configuration can be or can be similar to a ConfiguredGrantConfig IE (e.g., as specified in 3GPP specification 38.331).

The DU 174 configures the timing advance validity threshold (e.g., including a RSRP range) for the UE 102 to determine whether the UE 102 can initiate SDT using the configured grant configuration for CG-SDT as described for FIG. 4. In accordance with the timing advance validity threshold, the UE 102 can evaluate whether a stored timing advance value is still valid. If the UE 102 determines that the stored timing advanced value is invalid, the UE 102 can initiate a RA-SDT with the CU 172 via the DU 174 as described for FIG. 4. In some implementations, the SDT DU configuration can be an SDT-MAC-PHY-CG-Config IE or SDT-MAC-PHY-Config IE. In some implementations, the “SDT DU configuration” can be replaced by “CG-SDT configuration(s)”. In such implementations, the configurations in the SDT DU configuration are specific for CG-SDT. In other implementations, some of the configuration(s) in the SDT DU configuration described above can be grouped into CG-SDT configuration(s) and the other configuration(s) (e.g., the BSR configuration and/or PHR configuration) in the SDT DU configuration are not within the CG-SDT configuration(s). In some implementations, the SDT DU configuration includes the CG-SDT configuration(s). In such cases, the other configuration(s) can be configured for CG-SDT or RA-SDT.

In some implementations, the DU 174 starts or restarts a DU CG-SDT timer in response to or after receiving the SDT request indication, generating the CG-SDT configuration(s), receiving 328 the second CU-to-DU message, transmitting 330 the CG-SDT configuration(s) to the CU 172, receiving 332 the third CU-to-DU message, or transmitting 334 the CG-SDT configuration(s) to the UE 102. In some implementations, the DU 174 starts or restarts the DU CG-SDT timer with a timer value to manage the CG-SDT configuration(s). In some implementations, the timer value is the same as the CG-SDT time alignment timer value. In other implementations, the timer value is close to (e.g., within a predetermined range of) the CG-SDT time alignment timer value. For example, the timer value can be larger than and close to the CG-SDT time alignment timer value. In another example, the timer value can be smaller than and close to the CG-SDT time alignment timer value. When the DU CG-SDT timer expires, the DU 174 releases the CG-SDT configuration(s) or the CG resources configured in the CG-SDT configuration(s). While or after releasing the CG-SDT configuration(s), the DU 174 refrains from receiving PUSCH transmissions from the UE 102 on the radio resources that were reserved or configured for the CG-SDT configuration(s). While or after releasing the CG-SDT configuration(s), the DU 174 can schedule transmissions for other UE(s) on the radio resources that were reserved or configured for the CG-SDT configuration(s).

As described above, the RRC release message 334 in some implementations includes the CG-SDT configuration(s). In some implementations, the UE 102 starts or restarts the UE CG-SDT timer (i.e., a first UE CG-SDT timer) with the CG-SDT time alignment timer value, in response to or after receiving the CG-SDT configuration(s). When the UE CG-SDT timer expires, the UE 102 can release the CG-SDT configuration(s). Alternatively, when the UE CG-SDT timer expires, the UE 102 retains the CG-SDT configuration(s) and refrains from transmitting UL transmissions (e.g., MAC PDUs) on the CG resources. In some such cases, the UE 102 releases the CG resources or determines that the CG resources are not valid. When the UE CG-SDT timer expires, the UE 102 can release the SRS configuration or SRS resources configured in the SRS configuration. Alternatively, when the UE CG-SDT timer expires, the UE 102 retains the SRS configuration and refrains from transmitting one or more SRSs to the DU 174 on the SRS resources.

While the UE CG-SDT timer is running, the UE 102 in the inactive state communicates (e.g., performs CG-SDT, transmits SRS(s), and/or receives DL control signals (e.g., DCI) and/or data) with the DU 174 via the dedicated DL BWP and dedicated UL BWP. In some implementations, when the UE CG-SDT timer expires, the UE 102 in the inactive state can switch to an initial DL BWP and an initial UL BWP from the dedicated DL BWP and dedicated UL BWP, respectively. In such cases, the UE 102 may retune transceivers of the UE 102 to switch to the initial DL BWP and initial UL BWP. In some implementations, the UE 102 in the inactive state can switch to the initial DL BWP and initial UL BWP to perform a random access procedure, while the UE 102 is configured with the CG-SDT configuration. The UE 102 can perform the random access procedure for different cases as described below. In some implementations, the UE 102 in the inactive state can switch to the initial DL BWP and initial UL BWP to perform measurements on SSBs transmitted by the DU 174 on the initial DL BWP.

In some implementations, the DU 174 or CU-CP 172A can configure the dedicated DL BWP and dedicated UL BWP to be the same as or include the initial DL BWP and initial UL BWP respectively. In such implementations, when the UE CG-SDT timer expires, the UE 102 may not switch to the initial DL BWP and initial UL BWP from the dedicated DL BWP and dedicated UL BWP, respectively. In such cases, the UE 102 may not retune transceivers of the UE 102 due to switching BWPs. In such cases, when the UE 102 in the inactive state performs a random access procedure with the DU 174, the UE 102 can perform the random access procedure without switching to the initial DL BWP and initial UL BWP. In such cases, the UE 102 can perform measurements on SSBs transmitted by the DU 174 within the initial DL BWP, while performing CG-SDT with the DU 174.

In some implementations, in response to or after the UE CG-SDT timer expires, the UE 102 can perform RA-SDT with the CU 172 via the DU 174 on the initial UL BWP and initial DL BWP, as described for FIG. 4. That is, the UE 102 determines that RA-SDT is valid in response to or after the UE CG-SDT timer expires.

In some implementations, the DU 174 reserves CG resources configured in the CG configuration(s). In some implementations, the DU 174 releases the CG resources when releasing the SDT DU configuration or the CG-SDT configuration(s) or when the DU CG-SDT timer expires. In further implementations, the DU 174 releases the SRS resources configured in the SRS configuration, when releasing the SDT DU configuration or the CG-SDT configuration(s) or when the DU CG-SDT timer expires.

In cases where the DU 174 does not provide the CG-SDT configuration(s) or the SDT DU configuration to the CU-CP 172A, the DU 174 releases all signaling and user data transport resources for the UE 102 in response to the third CU-to-DU message. In cases where the DU 174 provides the SDT DU configuration or the CG-SDT configuration(s) to the CU-CP 172A, the DU 174 retains signaling and user data transport resources for the UE 102 in response to or after receiving the third CU-to-DU message.

In cases where the SDT DU configuration does not include a configuration for CG-SDT, the CU-CP 172A and/or the DU 174 only configures RA-SDT for the UE 102. In such cases, the UE 102 can perform RA-SDT with the CU 172 via the DU 174 as described for FIG. 4.

In some implementations, the CU-CP 172A may not request the DU 174 to provide an SDT DU configuration when determining to cause the UE 102 to transition to the inactive state with SDT configured. In some such cases, the events 328 and 330 can be omitted, and the CU-CP 172A does not include the SDT DU configuration in the RRC release message. Alternatively, the CU-CP 172A may generate the SDT DU configuration by itself without requesting the DU 174 to provide an SDT DU configuration and include the SDT DU configuration in the RRC release message.

In some implementations, the DU 174 may not include an SDT DU configuration in the second DU-to-CU message, e.g., if or because the UE 102 does not support CG-SDT, the DU 174 does not support CG-SDT or the DU 174 does not have available radio resources for CG-SDT. In such cases, the RRC release message does not include an SDT DU configuration. Otherwise, the DU 174 can transmit an SDT DU configuration to the CU-CP 172A as described above. In some implementations, the DU 174 may not include a configuration for CG-SDT in the SDT DU configuration in the second DU-to-CU message, e.g., if or because the UE 102 does not support CG-SDT, the DU 174 does not support CG-SDT or the DU 174 does not have available radio resources for CG-SDT. In such cases, the SDT DU configuration does not include a CG-SDT configuration. Otherwise, the DU 174 can include the CG-SDT configuration(s) in the SDT DU configuration as described above.

In some implementations, the CU-CP 172A may request the DU 174 to provide an SDT DU configuration as described above, in cases where the UE 102 supports CG-SDT and/or the DU 174 supports CG-SDT. In cases where the UE 102 does not support CG-SDT or the DU 174 does not support CG-SDT, the CU-CP 172A does not request the DU 174 to provide an SDT DU configuration. The CU-CP 172A can receive a UE capability (e.g., UE-NR-Capability IE) of the UE 102 from the UE 102, the CN 110 (e.g., MME 114 or AMF 164) or the base station 106, while the UE operates 302 in the connected state. The UE capability indicates whether the UE 102 supports CG-SDT. Thus, the CU-CP 172A can determine whether the UE supports CG-SDT in accordance with the UE capability. In some implementations, the CU-CP 172A can receive from the DU 174 a DU-to-CU message indicating whether the DU 174 supports CG-SDT. The DU-to-CU message can be the second DU-to-CU message, the message of the event 308 or 316, or a non-UE associated message (e.g., a non-UE associated F1AP message defined in 3GPP specification 38.473).

In some implementations, the DU 174 may determine whether to provide an SDT DU configuration for the UE 102 to the CU-CP 172A, depending on whether the UE 102 supports CG-SDT or not. In addition to whether the UE 102 supports CG-SDT or not, the DU 174 may additionally determine whether to provide an SDT DU configuration for the UE 102 to the CU-CP 172A, depending on whether the DU 174 supports CG-SDT or not. In cases where the UE 102 supports CG-SDT and/or the DU 174 supports CG-SDT, the DU 174 provides an SDT DU configuration for the UE 102 to the CU-CP 172A as described above. In cases where the UE 102 does not support CG-SDT or the DU 174 does not support CG-SDT, the DU 174 does not provide an SDT DU configuration for the UE 102 (e.g., the DU 174 does not include the SDT DU configuration in the second DU-to-CU message). The DU 174 can receive the UE capability from the CU-CP 172A, while the UE 102 operates 302 in the connected state or in the inactive state before the event 302. Thus, the DU 174 can determine whether the UE 102 supports CG-SDT in accordance with the UE capability. In some implementations, the DU 174 can send a DU-to-CU message to the CU-CP 172A to indicate whether the DU 174 does support CG-SDT or not, as described above.

Referring now to FIG. 4, a scenario 400 depicts small data transmission. In the scenario 400, the base station 104 includes a CU 172 and a DU 174. The CU 172 includes a CU-CP 172A and a CU-UP 172B. In the scenario 400, the UE 102 initially operates 402 in an inactive state with SDT configured. In some implementations or scenarios, the UE 102 can transition to the inactive state with SDT configured from the connected state as described for FIG. 3. In such implementations, the UE can receive a first SDT CU configuration and/or a first SDT DU configuration in an RRC release message (e.g., event 334). In other implementations or scenarios, the UE 102 can transition to the inactive state with SDT configured from the inactive state without SDT configured. For example, the UE 102 can receive, from a base station (e.g., the base station 104 or base station 106), an RRC release message transitioning the UE 102 to the inactive state and not configuring SDT (e.g., indicating releasing SDT or not including an SDT configuration in the RRC release message). In this case, the UE 102 transitions to the inactive state without SDT configured in response to the RRC release message. The UE 102 in the inactive state with or without SDT configured may perform a RAN notification area (RNA) update with the base station without state transitions. During the RNA update, the UE 102 receives another RRC release message including a first SDT CU configuration and/or a first SDT DU configuration from the base station, similar to the RRC release message of the event 334.

Later in time, the UE 102 operating in the inactive state with SDT configured initiates SDT. In response to or after initiating SDT, the UE 102 generates an initial UL MAC PDU, which includes a UL RRC message and transmits 404 the initial UL MAC PDU to the DU 174 on a cell (e.g., the cell 124 or another cell of the base station 104 not shown in FIG. 1A). The following events between the UE 102 and the DU 174 occur on the cell. The UE 102 may start an SDT session timer in response to initiating the SDT. In some implementations, the SDT session timer can be a new timer defined in an RRC specification (e.g., v17.0.0). The DU 174 retrieves the UL RRC message from the initial UL MAC PDU, generates a first DU-to-CU message including the UL RRC message, and sends 406 the first DU-to-CU message to the CU-CP 172A. In some implementations, the first DU-to-CU message is an Initial UL RRC Message Transfer message. In other implementations, the first DU-to-CU message is a UL RRC Message Transfer message.

In scenarios in which the UE 102 initiates SDT to transmit UL data (e.g., a data packet) qualifying for SDT, the UE 102 includes the UL data in the initial UL MAC PDU that the UE 102 transmits 404. In scenarios in which the UE 102 initiates SDT to receive DL data, the UE 102 does not include an UL data packet in the initial UL MAC PDU that the UE 102 transmits 404. The UE 102 can initiate SDT to receive DL data in response to receiving a paging message from the DU 174. In such scenarios, the UE 102 can include an SDT indication in the initial UL MAC PDU or the UL RRC message to indicate to the base station 104 that the UE 102 is initiating SDT to receive DL data.

In some implementations, the UE 102 in the inactive state performs a random access procedure with the DU 174 to transmit 404 the UL MAC PDU. In some such implementations, the SDT is an RA-SDT. For example, the random access procedure can be a four-step random access procedure or a two-step random access procedure. In the case of the four-step random access procedure, the UE 102 transmits a random access preamble to the DU 174 and, in response, the DU 174 transmits, to the UE 102, a random access response (RAR) including an uplink grant, a temporary C-RNTI, and a timing advance command, and the UE 102 transmits 404 the UL MAC PDU to the DU 174 in accordance with the uplink grant. The DU 174 receives 404 the UL MAC PDU in accordance with the uplink grant in the RAR and transmits a DL MAC PDU including a contention resolution MAC control element to the UE 102 in response. In implementations with a two-step random access procedure, the UE 102 transmits 404 to the DU 174 a MsgA including a random access preamble and the UL MAC PDU in accordance with two-step random access configuration parameters. The UE 102 can receive a message B (MsgB) including a temporary C-RNTI and a timing advance command from the DU 174 in response to the MsgA. The DU 174 can include a contention resolution MAC control element in the MsgB. The UE 102 receives the two-step random access configuration parameters in system information broadcast by the DU 174 on the cell 124 before transmitting 404 the UL MAC PDU. The DU 174 receives 404 the UL MAC PDU in accordance with the two-step random access configuration parameters.

When the UE 102 succeeds in a contention resolution in the random access procedure (e.g., receives the contention resolution MAC control element), the UE 102 discards a previously retained C-RNTI (e.g., described for FIG. 3) and determines the temporary C-RNTI to be a new C-RNTI. The UE 102 monitors a PDCCH from the DU 174 using the C-RNTI to communicate 418 data (e.g., UL data and/or DL data) with the base station 104. In details, the UE 102 receives a DCI and a cyclic redundancy check (CRC) of the DCI on a PDCCH from the DU 174 and verifies the CRC using the C-RNTI. The DCI can include an uplink grant or a downlink assignment. If the UE 102 verifies the CRC is correct and the DCI includes an uplink grant, the UE 102 uses the uplink grant to transmit 418 UL data to the DU 174. If the UE 102 verifies the CRC is correct and the DCI includes a downlink assignment, the UE 102 uses the downlink assignment to receive 418 DL data from the DU 174.

In other implementations, the UE 102 can transmit 404 the UL MAC PDU on CG resources when the UE 102 receives or is configured with CG configuration(s) (e.g., as described for FIG. 3). In some such cases, the UE 102 performs CG-SDT. The UE 102 does not perform a random access procedure for transmitting 404 the UL MAC PDU. As such, the DU 174 receives 404 the UL MAC PDU on the CG resources. In such implementations, in response to or after generating or transmitting 404 the UL MAC PDU, the UE 102 can start a UE timer (e.g., a second UE CG-SDT timer), for example if the CU-CP 172A or the DU 174 configures the UE 102 to apply the UE timer during SDT. In some implementations, the UE 102 can start the UE timer with a UE timer value (e.g., cg-SDT-RetransmissionTimer value). In some implementations, the UE 102 can receive an RRC release message including the UE timer value from the base station 104, similar to the events 332, 334, 432, 434. The CP-CP 172A can include the UE timer value in a CG-SDT configuration and transmits the RRC release message including the CG-SDT configuration to the UE 102 via the DU 174. In other implementations, the UE 102 can receive the UE timer value in a system information block broadcast by the DU 174 via the cell 124. While the UE timer is running, the UE 102 in the inactive state or SDT session refrains from retransmitting the UL MAC PDU on the CG resources. In some implementations, in response to or after receiving 404 the UL MAC PDU on the CG resources, the DU 174 starts a DU timer (e.g., a second DU CG-SDT timer) with a DU timer value. In some implementations, the DU timer value can be the same as or larger than the UE timer value. While the DU timer is running, the DU 174 processes UL transmissions received from the UE 102 on the CG resources as new transmissions.

In some implementations, the UE 102 can transmit 418 subsequent UL MAC PDU(s), including one or more UL data packets, on the CG radio resources. In some implementations, the UE 102 can transmit 418 the subsequent UL MAC PDU(s) on radio resources configured in uplink grant(s) received on PDCCH(s) from the DU 174. In some implementations, the UE 102 can transmit 418 some of the subsequent UL MAC PDU(s) on radio resources configured in the CG configuration and 418 the other of the subsequent UL MAC PDU(s) on radio resources configured in the uplink grant(s).

In cases where the UE 102 transmits 418 subsequent UL MAC PDU(s) on the CG resources, the UE 102 can start or restart the timer (e.g., the second UE CG-SDT timer) in response to or after generating or transmitting 418 each of the subsequent UL MAC PDU(s). The UE 102 can start or restart the timer with the timer value as described above. While the UE timer is running, the UE 102 in the inactive state or SDT session refrains from retransmitting the UL MAC PDU. In some implementations, in response to or after receiving 418 each of the subsequent UL MAC PDU(s) on the CG resources, the DU 174 starts or restarts the DU timer (e.g., the second DU CG-SDT timer) according to the DU timer value. While the DU timer is running, the DU 174 processes UL transmissions received from the UE 102 on the CG resources as new transmissions.

If the UE 102 includes UL data in the initial UL MAC PDU 404, the DU 174 retrieves the UL data from the initial UL MAC PDU. In such cases, the DU 174 can include the UL data in the DU-to-CU message at event 406. Alternatively, the DU 174 can send 415 a DU-to-CU message including the UL data to the CU-CP 172A. In some such implementations, the UL data can include or be a PDCP PDU, an RRC PDU, NAS PDU or an LTE positioning protocol (LPP) PDU. The PDCP PDU can include an RRC PDU. As another alternative, the DU 174 can send 416 the UL data to the CU-UP 172B separately via a user-plane (UP) connection as described below. In this alternative, the UL data can include or be a PDCP PDU and the PDCP PDU can include a SDAP PDU, an IP packet or an Ethernet packet.

After receiving 406 the first DU-to-CU message, the CU-CP 172A in some implementations can send 408 a UE Context Setup Request message to the DU 174 to establish a UE Context of the UE 102 at the DU 174. In the UE Context Setup Request message, the CU-CP 172A can include transport layer information for one or more GTP-U tunnels between the CU-UP 172B and DU 174 so that the DU 174 can transmit the UL data and/or subsequent UL data (e.g., in small data communication 418) via the one or more GTP-U tunnels to the CU-UP 172B. In response, the DU 174 can send 410 a UE Context Setup Response message to the CU-CP 172A. After receiving 406 the first DU-to-CU message, transmitting 408 the UE Context Setup Request message, or receiving 410 the UE Context Setup Response message, the CU-CP 172A transmits 412 to the CU-UP 172B a Bearer Context Modification Request message to resume data transmission for the UE 102. In response, the CU-UP 172B resumes data transmission for the UE 102 and transmits 414 a Bearer Context Modification Response message to the CU-CP 172A. After receiving 408 the UE Context Setup Request message or transmitting 410 the UE Context Setup Response message, the DU 174 can transmit 415 the DU-to-CU message including the UL data to the CU-CP 172A, such as in cases where the UL data of the event 404 includes an RRC message or is associated with an SRB (e.g., SRB1 or SRB2). In cases where the UL data is associated with a DRB, the DU 174 can transmit 416 the UL data to the CU-UP 172B.

In some implementations, the CU-CP 172A can include transport layer information of the CU-UP 172B in the UE Context Setup Request message. The transport layer information of the CU-UP 172B can include an IP address and/or an uplink tunnel endpoint ID (e.g., TEID). The DU 174 can transmit 416 the UL data to the CU-UP 172B using the transport layer information of the CU-UP 172B. In cases where the UE 102 has subsequent UL data (e.g., one or more UL data packets) to transmit, the UE 102 can transmit 418 one or more subsequent UL MAC PDUs including the subsequent UL data to the DU 174. In turn, the DU 174 retrieves the subsequent UL data from the subsequent UL MAC PDU(s). In cases where the subsequent UL data is associated with one or more SRB (e.g., SRB1 and/or SRB2), the DU 174 transmits 418 the one or more DU-to-CU messages (e.g., UL RRC Message Transfer message(s)) including the subsequent UL data to the CU-CP 172A. Each DU-to-CU message can include a particular UL data packet of the subsequent UL data. In cases where the CU-CP 172A receives DL data from the CN 110 or edge server, the CU-CP 172A can transmit 418 one or more CU-to-DU messages (e.g., DL RRC Message Transfer message(s)) including the DL data (e.g., one or more DL data packets) to the DU 174. In turn, the DU 174 transmits 418 one or more DL MAC PDUs including the DL data to the UE 102 operating in the inactive state. In some implementations, the DL data can include or be NAS PDU(s) and/or LPP PDU(s).

In cases where the subsequent UL data is associated with one or more DRBs, the DU 174 transmits 418 the subsequent UL data to the CU-UP 172B, similar to the event 416. In some implementations, the DU 174 can include DU transport layer information of the DU 174 in the UE Context Setup Response message. In turn, the CU-CP 172A can include the transport layer information of the DU 174 in the Bearer Context Modification Request message. The transport layer information of the DU 174 can include an IP address and/or a downlink TEID. In cases where the CU-UP 172B receives DL data from the CN 110 or edge server, the CU-UP 172B can transmit 418 the DL data (e.g., one or more DL data packets) to the DU 174 using the transport layer information of the DU 174. In turn, the DU 174 transmits 418 one or more DL MAC PDUs including the DL data to the UE 102 operating in the inactive state.

In some implementations, the UE 102 can include a buffer status report or a power headroom report in the initial and/or subsequent UL MAC PDU(s), e.g., in accordance with the BSR configuration and/or PHR configuration, respectively. In the buffer status report, the UE 102 can include or indicate its buffer status for one or more logical channels or logical channel groups. In the power headroom report, the UE 102 can include or indicate power headroom status or value.

In some example scenarios, the subsequent UL data and/or DL data described above include Internet Protocol (IP) packet(s), an Ethernet packet(s), or an application packet(s). In other scenarios, the UL data can include or be PDU(s) (e.g., RRC PDU(s), PDCP PDU(s) or RLC PDU(s)) that includes RRC message(s), NAS message(s), IP packet(s), Ethernet packet(s), or application packet(s).

The events 404, 406, 408, 410, 412, 414, 415 and 416 are collectively referred to in FIG. 4 as a small data transmission procedure 492.

In some implementations, the UL RRC message is an (existing) RRC resume request message (e.g., an RRCResumeRequest message, an RRCResumeRequest1 message, an RRCConnectionResumeRequest message, or an RRCConnectionResumeRequest1 message). In other implementations, the UL RRC message can be a new RRC resume request message, similar to the existing RRC resume request message. The new RRC resume request message may be a format of an existing RRC resume request message. In the case of the downlink SDT, the UL RRC message can include an SDT indication, which can be a field or information element (IE) (e.g., resumeCause or ResumeCause). In some implementations, the UL RRC message is a common control channel (CCCH) message.

After the UE 102 transmits 404 the UL MAC PDU or communicates 418 the subsequent UL data and/or DL data with the DU 174, the CU-CP 172A can determine to stop the SDT for the UE 102 based on data inactivity of the UE 102 (i.e., the UE 102 in the inactive state has no data activity with the base station 104). After the UE 102 transmits 404 the UL MAC PDU or communicates 418 the subsequent UL data and/or DL data with the DU 174, the UE 102 in the inactive state determines or detects data inactivity and transmits 420, to the DU 174, UE assistance information (e.g., a UEAssistanceInformation message) indicating that the UE 102 prefers or requests to stop the SDT. In turn, the DU 174 transmits 421 a UL RRC Message Transfer message including the UE assistance information to the CU-CP 172A. Therefore, the CU-CP 172A can determine that the UE 102 is in a state of data inactivity based on the UE assistance information.

In further implementations, the DU 174 can perform data inactivity monitoring for the UE 102. The CU-CP 172A can transmit a CU-to-DU message (e.g., the UE Context Setup Request message of the event 408 or a UE Context Modification Request message) to the DU 174 to request or command the DU 174 to perform the data inactivity monitoring. In cases where the DU 174 detects or determines that the UE 102 is in a state of data inactivity during the monitoring, the DU 174 can transmit 422 an inactivity notification (e.g., UE Inactivity Notification message) to the CU-CP 172A. Thus, the CU-CP 172A can determine that the UE 102 is in a state of data inactivity based on the inactivity notification received from the DU 174.

In yet further implementations, the CU-UP 172B can perform data inactivity monitoring for the UE 102. The CU-CP 172A can transmit a CP-to-UP message to the CU-UP 172B to request or command the CU-UP 172B to perform the data inactivity monitoring. In some implementations, the CP-to-UP message can be a Bearer Context Setup Request message or a Bearer Context Modification Request message before the UE 102 initiates the SDT. In other implementations, the CP-to-UP message can be a Bearer Context Modification Request message during the SDT (e.g., the event 412). In cases where the CU-UP 172B detects or determines that the UE 102 is in a state of data inactivity during the monitoring, the CU-UP 172B can transmit 423 an inactivity notification (e.g., Bearer Context Inactivity Notification message) to the CU-CP 172A. Thus, the CU-CP 172A can determine that the UE 102 is in a state of data inactivity based on the inactivity notification received from the CU-UP 172B. In some implementations, the CU-CP 172A can determine that the UE 102 is in a state of data inactivity based on the UE assistance information, inactivity notification of the event 422 and/or inactivity notification of the event 423.

After a certain period of data inactivity, the CU-CP 172A can determine that neither the CU 172 nor the UE 102 has transmitted any data in the downlink direction or the uplink direction, respectively, during the certain period. In response to the determination, the CU-CP 172A can determine to stop the SDT. Alternatively, the CU-CP 172A can determine to immediately stop the SDT for the UE 102 in response to determining that the UE 102 is in a state of data inactivity.

In response to or after determining that the UE 102 is in a state of data inactivity (for the certain period) or determining to cause the UE 102 to transition to the inactive state with SDT configured, the CU-CP 172A sends 424 to the CU-UP 172B a Bearer Context Modification Request message to suspend data transmission for the UE 102. In response, the CU-UP 172B suspends data transmission for the UE 102 and sends 426 a Bearer Context Modification Response message to the CU-CP 172A. In response to or after determining that the UE 102 is in a state of data inactivity (for the certain period) or determining to cause the UE 102 to transition to the inactive state with SDT configured, the CU-CP 172A sends 428 a second CU-to-DU message (e.g., a UE Context Modification Request message) to instruct the DU 174 to provide an SDT DU configuration (e.g., a second SDT DU configuration) for the UE 102. In some implementations, the CU-CP 172A can include an SDT request indication (e.g., a field or IE) to request an SDT DU configuration in the second CU-to-DU message. In response to the SDT request indication or the second CU-to-DU message, the DU 174 transmits 430 a second DU-to-CU message (e.g., UE Context Modification Response message) including the second SDT DU configuration to the CU-CP 172A. Alternatively, the DU 174 does not include the second SDT DU configuration in the second DU-to-CU message. Instead, the DU 174 sends to the CU-CP 172A another DU-to-CU message (e.g., UE Context Modification Required message) including the second SDT DU configuration, after receiving the second CU-to-DU message or transmitting the second DU-to-CU message. In some alternative implementations, the CU-CP 172A can transmit the second CU-to-DU message and receive the second DU-to-CU message or another DU-to-CU message, before determining that the UE 102 is in a state of data inactivity.

In response to determining to cause the UE 102 to transition to the inactive state with SDT configured, the CU-CP 172A can generate an RRC release message (e.g., RRCRelease message RRCConnectionRelease message) to cause the UE 102 to transition to the inactive state. The CU-CP 172A can include the second SDT DU configuration (if obtained from the DU 174) and a second SDT CU configuration in the RRC release message.

Alternatively, the CU-CP 172A may not include an SDT configuration in the RRC release message. In this alternative, the CU-CP 172A can indicate to the UE 102 to release or retain the first SDT CU configuration and/or the first SDT DU configuration in the RRC release message. For example, the CU-CP 172A can include a release indication, indicating to release the first SDT CU configuration or the first SDT DU configuration, in the RRC release message. If the RRC release message does not include the release indication, the UE 102 retains the first SDT CU configuration and/or the first SDT DU configuration.

The CU-CP 172A then sends 432 to the DU 174 a third CU-to-DU message including the RRC release message. In turn, the DU 174 transmits 434 the RRC release message to the UE 102. In some implementations, the DU 174 generates a MAC PDU including the RRC release message and transmits 334 the MAC PDU to the UE 102. The RRC release message instructs the UE 102 to transition to the inactive state. The UE 102 stops the SDT and remains 436 in the inactive state upon receiving 434 the RRC release message.

The events 420, 421, 422, 423, 424, 426, 428, 430, 432 and 434 are collectively referred to in FIG. 4 as an SDT complete procedure 494.

During an SDT session (i.e., events 492 and 494), the UE 102 monitors a PDCCH using a C-RNTI to receive a DCI. In some implementations, the UE 102 receives the C-RNTI in the random access procedure described for the event 404. In other implementations, the UE 102 can receive and retain the C-RNTI as described for FIG. 3. In response to or after receiving 434 the RRC release message, the UE 102 ends the SDT session and stops using the C-RNTI to monitor a PDCCH. The UE 102 may retain the C-RNTI in response to or after receiving 434 the RRC release message or transitioning 436 to the inactive state from the connected state. In cases where the RRC release message 434 configures CG-SDT, the UE 102 in some implementations can retain the C-RNTI. In cases where the RRC release message 434 does not configure or releases CG-SDT, the UE 102 in some implementations can release the C-RNTI.

After the UE 102 ends the SDT session, the UE 102 in the inactive state monitors a PDCCH using a paging RNTI (P-RNTI). In some implementations, the CU-CP 172A determines to page the UE 102 to receive a mobile-terminated call or data. In response to the determination, the CU-CP 172A can send a CU-to-DU message (e.g., Paging message) to the DU 174 to request the DU 174 to page the UE 102. In response to the CU-to-DU message, the DU 174 generates a paging message, a DCI to schedule a PDSCH transmission including the paging message, and a CRC of the DCI. The DU 174 further scrambles the CRC with the P-RNTI to obtain a scrambled C-RNTI and transmits the DCI and scrambled CRC on a PDCCH that the UE 102 monitors. The UE 102 receives the DCI and the scrambled CRC on the PDCCH and verifies the scrambled CRC with the P-RNTI. In cases where the UE 102 verifies that the scrambled CRC is valid, the UE 102 receives and decodes the PDSCH transmission in accordance with the DCI and retrieves the paging message from the PDSCH transmission.

In some implementations, the second SDT CU configuration can be the same as the first SDT CU configuration. In other implementations, the second SDT CU configuration can be different from the first SDT CU configuration. The UE 102 can update (e.g., replace or modify) the first SDT CU configuration with the second SDT CU configuration. In some implementations, the CU-CP 172A can include an indication in the RRC release message to indicate to the UE 102 to update the first SDT CU configuration with the second SDT CU configuration. In such implementations, the UE 102 can update the first SDT CU configuration with the second SDT CU configuration in response to the indication. In other implementations, the CU-CP 172A includes a modification indication in the RRC release message to indicate to the UE 102 to modify the first SDT CU configuration with the second SDT CU configuration. In such implementations, the UE 102 can modify the first SDT CU configuration with the second SDT CU configuration in response to the modification indication. In yet other implementations, the CU-CP 172A includes a setup indication in the RRC release message to indicate to the UE 102 to replace the first SDT CU configuration with the second SDT CU configuration. In such implementations, the UE 102 can replace the first SDT CU configuration with the second SDT CU configuration in response to the setup indication.

In some implementations, the second SDT DU configuration is the same as the first SDT DU configuration. In other implementations, the second SDT DU configuration is different than the first SDT DU configuration. The UE 102 can update (e.g., replace or modify) the first SDT DU configuration with the second SDT DU configuration. In some implementations, the DU 174 includes an indication in the second SDT DU configuration to indicate to the UE 102 to update the first SDT DU configuration with the second SDT DU configuration. In some such implementations, the UE 102 updates the first SDT DU configuration with the second SDT DU configuration in response to the indication. In other implementations, the DU 174 includes a modification indication in the second SDT DU configuration to indicate to the UE 102 to modify the first SDT DU configuration with the second SDT DU configuration. In further such implementations, the UE 102 modifies the first SDT DU configuration with the second SDT DU configuration in response to the modification indication. In yet other implementations, the DU 174 includes a setup indication in the second SDT DU configuration to indicate to the UE 102 to replace the first SDT DU configuration with the second SDT DU configuration. In some such implementations, the UE 102 replaces the first SDT DU configuration with the second SDT DU configuration in response to the setup indication.

In cases where the CU-CP 172A and/or the DU 174 support delta configuration, the CU-CP 172A may not send 428 the CU-to-DU message to obtain the second SDT DU configuration from the DU 174. Unless a condition for releasing the first SDT configuration is satisfied, the DU 174 retains the first SDT DU configuration. Alternatively, the CU-CP 172A can include the first SDT DU configuration in the second CU-to-DU message to cause the DU 174 to retain the first SDT DU configuration. In these cases, the CU-CP 172A may not include an SDT DU configuration and/or an SDT CU configuration in the RRC release message to cause the UE 102 to continue using the first SDT CU configuration and/or the first SDU DU configuration. In some implementations, the CU-CP 172A may not include a release indication in the RRC release message in order to configure the UE to continue using the first SDT DU configuration and/or the first SDT CU configuration. The release indication indicates releasing the previously received SDT DU configuration and/or the SDT CU configuration. In case the CU-CP 172A include the release indication in the RRC release message, the UE 102 releases the first SDT CU configuration and/or the first SDT DU configuration in response to the release indication.

In cases where the CU-CP 172A and/or DU 174 do not support a delta configuration, the CU-CP 172A may include the SDT DU configuration and/or the SDT CU configuration in the RRC release message as described above.

In response to the third CU-to-DU message, the DU 174 can retain the second SDT DU configuration and may or may not release the first non-SDT DU configuration and/or second non-SDT DU configuration. The DU 174 can send a third DU-to-CU message (e.g., a UE Context Release Complete message or a UE Context Modification Response message) to the CU-CP 172A in response to the third CU-to-DU message. In some implementations, if the RRC release message instructs the UE 102 to transition to the inactive state (i.e., RRC_IDLE), the UE 102 releases a non-SDT configuration (e.g., the first non-SDT DU configuration, first non-SDT CU configuration, second non-SDT DU configuration, and/or second non-SDT CU configuration described for FIG. 3) and at least one SDT configuration (e.g., the SDT DU configuration and/or SDT CU configuration described for FIG. 3).

The events 420, 421, 422, 423, 424, 426, 428, 430, 432, and 434 are collectively referred to in FIG. 4 as an SDT complete procedure 494, similar to the procedure 394. Examples and implementations for events 320, 321, 322, 323, 324, 326, 328, 330, 332, and 334 can apply to events 420, 421, 422, 423, 424, 426, 428, 430, 432, and 434, respectively. After stopping the SDT, the UE 102 can perform 493 another small data transmission procedure with the base station 104, similar to the procedure 492. After completing the procedure 493, the base station 104 can perform 495 an SDT complete procedure with the UE 102, similar to the procedure 494.

In some implementations, the CU-CP 172A may not request the DU 174 to provide an SDT DU configuration for transitioning the UE 102 to the inactive state with SDT configured. In such cases, the events 428 and 430 can omitted. In such cases, the CU-CP 172A does not include an SDT DU configuration in the RRC release message. Alternatively, the CU-CP 172A may generate the SDT DU configuration by itself and include the SDT DU configuration in the RRC release message.

In some implementations, the DU 174 may not include an SDT DU configuration in the second DU-to-CU message (e.g., if or because the UE 102 does not support CG-SDT, the DU 174 does not support CG-SDT, or the DU 174 does not have available radio resources for CG-SDT). In some such cases, the RRC release message does not include an SDT DU configuration. Otherwise, the DU 174 can include an SDT DU configuration as described above. In some implementations, the DU 174 may not include a CG-SDT configuration in the SDT DU configuration in the second DU-to-CU message (e.g., if or because the UE 102 does not support CG-SDT, the DU 174 does not support CG-SDT, or the DU 174 does not have available radio resources for CG-SDT). In such cases, the SDT DU configuration does not include a CG-SDT configuration. Otherwise, the DU 174 can include the at least one CG-SDT configuration in the SDT DU configuration as described above.

In some implementations, the CU-CP 172A may request the DU 174 to provide an SDT DU configuration as described above, in cases where the UE 102 supports CG-SDT and/or the DU 174 supports CG-SDT. In cases where the UE 102 does not support CG-SDT or the DU 174 does not support CG-SDT, the CU-CP 172A does not request the DU 174 to provide an SDT DU configuration. The CU-CP 172A can receive a UE capability (e.g., UE-NR-Capability IE) of the UE 102 from the UE 102, the CN 110 (e.g., MME 114 or AMF 164), or the base station 106. Depending on the implementation, the CU-CP 172A receives the UE capability before the UE 102 initiated the SDT, while the UE 102 operates 402 in the inactive state, while the UE 102 performs the SDT (e.g., in the UE Context Setup Request message of the event 408 or the CU-to-DU message of the event 428), or while the UE 102 operates in the connected state as described for FIG. 3.

In some implementations, the UE capability indicates whether the UE 102 supports CG-SDT. Thus, the CU-CP 172A can determine whether the UE 102 supports CG-SDT in accordance with the UE capability. In some implementations, the CU-CP 172A can receive, from the DU 174, a DU-to-CU message indicating whether the DU 174 supports CG-SDT. The DU-to-CU message can be the second DU-to-CU message, the message detailed with regard to the event 308 or 316, or a non-UE associated message (e.g., a non-UE associated F1AP message as defined in 3GPP specification 38.473).

In some implementations, the DU 174 determines whether to provide an SDT DU configuration for the UE 102 to the CU-CP 172A depending on whether the UE 102 supports CG-SDT or not. In addition to whether the UE 102 supports CG-SDT or not, the DU 174 may additionally determine whether to provide an SDT DU configuration for the UE 102 to the CU-CP 172A depending on whether the DU 174 supports CG-SDT or not. In cases where the UE 102 supports CG-SDT and/or the DU 174 supports or enables CG-SDT, the DU 174 provides an SDT DU configuration for the UE 102 to the CU-CP 172A as described above. In cases where the UE 102 does not support CG-SDT or the DU 174 does not support CG-SDT, the DU 174 does not provide an SDT DU configuration for the UE 102 (e.g., the DU 174 does not include the SDT DU configuration in the second DU-to-CU message). The DU 174 can receive the UE capability from the CU-CP 172A (e.g., while the UE 102 operates in the connected state or in the inactive state). Thus, the DU 174 can determine whether the UE 102 supports CG-SDT in accordance with the UE capability. In some implementations, the DU 174 can send a DU-to-CU message to the CU-CP 172A to indicate whether the DU 174 does support CG-SDT or not, as described above.

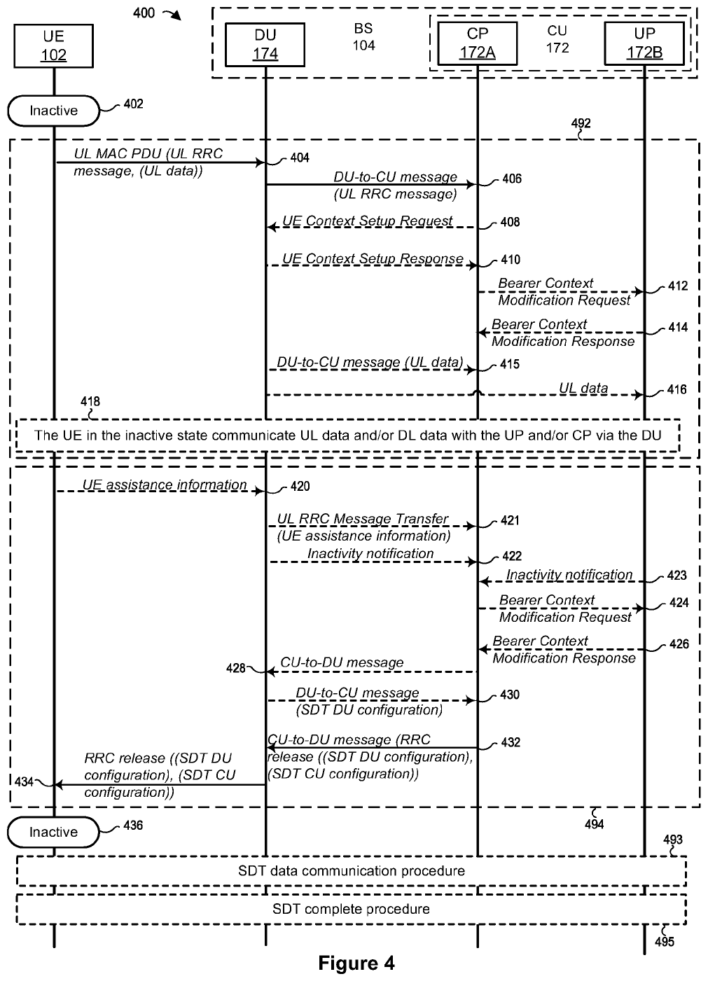

Referring now to FIG. 5A, a scenario 500A depicts small data transmission and transitioning from SDT to non-SDT. In the scenario 500A, the base station 104 includes a CU 172 and a DU 174. The CU 172 includes a CU-CP 172A and a CU-UP 172B. In the scenario 500A, the UE 102 initially operates 502 in an inactive state with SDT configured, similar to the event 402. The UE 102 then performs 592 a small data transmission procedure with the base station 104, similar to the event 492.

During the small data transmission procedure 592, the CU-CP 172A can determine whether to cause the UE 102 to transition to a connected state (e.g., based on UL or DL data activity of the UE 102). In some implementations, the UE 102 can transmit 503, to the DU 174, a non-SDT indication message to indicate that UL data is available or request to transition to the connected state. In some implementations, the UE 102 can transmit 503, to the DU 174, the non-SDT indication message on radio resources configured in a CG configuration for SDT (or CG-SDT configuration). In other implementations, the UE 102 can receive an uplink grant on a PDCCH from the DU 174 using a C-RNTI and transmit 503, to the DU 174, the non-SDT indication message on radio resources configured in the uplink grant. In turn, the DU 174 transmits 505 a UL RRC Message Transfer message including the non-SDT indication message to the CU-CP 172A. The CU-CP 172A can determine to cause the UE 102 to transition to the connected state in response to or based on the non-SDT indication message. In other implementations, the CU-UP 172B receives DL data from the CN 110 and transmits 507 a DL data notification (e.g., DL Data Notification message) to the CU-CP 172A to indicate that DL data is available for transmission in response to receiving the DL data. The CU-CP 172A can determine to cause the UE 102 to transition to the connected state in response to or based on the DL data notification. In yet other implementations, the CU-CP 172A can determine to cause the UE 102 to transition to the connected state based on measurement results received from the UE 102. In yet other implementations, the CU-CP 172A receives DL data (e.g., NAS message(s)) from the CN 110 and can determine to cause the UE 102 to transition to the connected state in response to receiving the DL data.

In some implementations, the UL data and DL data is/are associated with radio bearer(s) (e.g., SRB(s) and/or DRB(s)). For example, the UL data includes RRC message(s) or NAS message(s) associated with SRB(s). In another example, the UL data includes IP packet(s) associated with DRB(s). In some implementations, the UE 102 can include ID(s) of the radio bearer(s) in the non-SDT indication message. Thus, the CU-CP 172A can determine whether to cause the UE 102 to transition to the connected state based on the ID(s). For example, if the radio bearer(s) identified by the ID(s) do not qualify for SDT, the CU-CP 172A can determine to cause the UE 102 to transition to the connected state. Otherwise, the CU-CP 172A can determine not to cause the UE 102 to transition to the connected state. In some implementations, the UE 102 can include data volume information for the UL data in the non-SDT indication message. Thus, the CU-CP 172A can determine whether to cause the UE 102 to transition to the connected state based on the data volume information. In one implementation, the data volume information includes a total data volume of the UL data, which can be quantized or rounded to a value that can be indicated in the data volume information. In another implementation, the data volume information includes a data volume for each of the radio bearer(s), which can be quantized or rounded to a value that can be indicated in the data volume information. For example, if the total data volume is above a predetermined threshold, the CU-CP 172A can determine to cause the UE 102 to transition to the connected state. Otherwise, the CU-CP 172A can determine not to cause the UE 102 to transition to the connected state. In another example, if the data volume for a particular radio bearer is above a predetermined threshold, the CU-CP 172A can determine to cause the UE 102 to transition to the connected state. Otherwise, the CU-CP 172A can determine not to cause the UE 102 to transition to the connected state. In yet another example, if the total data volume is above a predetermined threshold and the data volume for a particular radio bearer is above another predetermined threshold, the CU-CP 172A can determine to cause the UE 102 to transition to the connected state. Otherwise, the CU-CP 172A can determine not to cause the UE 102 to transition to the connected state.

In response to or after determining to cause the UE 102 to transition to the connected state, the CU-CP 172A transmits 506 a UE Context Request message (e.g., a UE Context Setup Request message or a UE Context Modification Request message) to the DU 174. In response, the DU 174 transmits 508 a UE Context Response message (e.g., a UE Context Setup Response message or a UE Context Modification Response message) to the CU-CP 172A. In some implementations, the DU 174 includes a non-SDT DU configuration (i.e., a first non-SDT DU configuration) in the UE Context Response message. After receiving the UE Context Response message, the CU-CP 172A transmits 510 a CU-to-DU message including an RRC resume message (e.g., an RRCResume message or an RRCConnectionResume message) to the DU 174. In turn, the DU 174 transmits 512 the RRC resume message to the UE 102. In some implementations, the DU 174 transmits 512 one or more PDUs including the RRC resume message to the UE 102. The PDU(s) can be MAC PDU(s) or RLC PDU(s). In some implementations, the CU-to-DU message is a DL RRC Message Transfer message or a UE Context Modification Request message. In the case of the UE Context Modification Request message, the DU 174 can transmit a UE Context Modification Response message to the CU-CP 172A in response. In response to the RRC resume message, the UE 102 transitions 513 to the connected state and transmits 514 an RRC resume complete message (e.g., an RRCResumeComplete message or an RRCConnectionResumeComplete message) to the DU 174. In cases where the UE Context Response message includes the non-SDT DU configuration, the CU-CP 172A includes the non-SDT DU configuration in the RRC resume message. The DU 174 transmits 516 a DU-to-CU message including the RRC resume complete message to the CU-CP 172A.

After determining to cause the UE 102 to transition to the connected state, the CU-CP 172A can transmit 517 a Bearer Context Request message (e.g., a Bearer Context Setup Request message or a Bearer Context Modification Request message) to the CU-UP 172B to indicate to the CU-UP 172B to resume all suspended radio bearer(s) for the UE 102. In response, the CU-UP 172B resumes all suspended radio bearer(s) for the UE 102 and transmits 519 a Bearer Context Response message (e.g., a Bearer Context Setup Response message or a Bearer Context Modification Response message) to the CU CP-172A. In some implementations, the CU-CP 172A can transmit 517 the Bearer Context Request message after transmitting 506 the UE Context Request message, receiving 508 the UE Context Response message, transmitting 510 the CU-to-DU message, or receiving 516 the DU-to-CU message. In cases where the CU-CP 172A determines no radio bearer(s) of the UE 102 is suspended when determining to cause the UE 102 to transition to the connected state, the CU-CP 172A does not transmit 517 the Bearer Context Request message to the CU-UP 172B.

In some implementations, the CU-CP 172A can include an indication indicating to the DU 174 to generate a non-SDT configuration in the UE Context Request message, and the DU 174 includes the first non-SDT DU configuration in the UE Context Response message in response to the indication. In yet other implementations, the CU-CP 172A stores a non-SDT DU configuration (i.e., a second non-SDT DU configuration) that a DU (e.g., the DU 174 or another DU or base station) used to communicate with the UE 102. The UE 102 can also store the second non-SDT DU configuration. In some such implementations, the CU-CP 172A includes the second non-SDT DU configuration in the UE Context Request message, and the DU 174 includes the first non-SDT DU configuration in the UE Context Response message in response to receiving the second non-SDT DU configuration. In some implementations, the first non-SDT DU configuration augments or replaces the second non-SDT DU configuration. Examples and implementations for the first and second non-SDT DU configurations are similar to the non-SDT DU configurations described above. In some implementations, the DU 174 transmits an additional DU-to-CU message (e.g., a UE Context Modification Required message) including the first non-SDT DU configuration to the CU-CP 172A instead of including the first non-SDT DU configuration in the UE Context Response message.

After transitioning to the connected state, the UE 102 communicates 518 UL data and/or DL data with the CU-CP 172A and/or CU-UP 172B via the DU 174. The UL data can include the UL data that causes the UE 102 to transmit the non-SDT indication message. The UL data can also include new UL data available for transmission. The DL data can include the DL data received from the CN 110 as described above. The DL data can also include new DL data received from the CN 110. In cases where the RRC resume message includes the first non-SDT DU configuration, the UE 102 communicates 518 with the DU 174 using the first non-SDT DU configuration. In cases where the second non-SDT DU configuration is not completely replaced by the first non-SDT DU configuration (i.e., the UE 102 does not release the second non-SDT DU configuration in response to the RRC resume message), the UE 102 can communicate 518 with the DU 174 using the configuration parameters in the second non-SDT DU configuration, which are not augmented by the first non-SDT DU configuration.

In some implementations, the DU 174 may not provide the first non-SDT DU configuration to the CU-CP 172A in the UE Context Response message and the additional DU-to-CU message. In such cases, the RRC resume message does not include the first non-SDT configuration, and the UE 102 and the DU 174 communicate 518 with one another using the second non-SDT DU configuration.

In some implementations, the UE 102 releases the SDT configuration(s) (e.g., the SDT CU configuration, the SDT DU configuration, and/or the CG-SDT configuration(s)) in response to the RRC resume message or transitioning to the connected state. In some implementations, the base station 104 (e.g., the CU-CP 172A and/or DU 174) releases the SDT configuration(s) in response to or after causing the UE 102 to transition to the connected state, receiving 510 the CU-to-DU message, or transmitting 510, 512 the RRC resume message. In other implementations, the base station 104 releases the SDT configuration(s) in response to or after receiving an acknowledgement (e.g., an RLC acknowledgement or a HARQ acknowledgement) for the PDU(s) including the RRC resume message. In yet other implementations, the base station 104 (e.g., the CU-CP 172A and/or DU 174) releases the SDT configuration(s) in response to or after communicating 506 the UE Context Request message or communicating 508 the UE Context Response message.

In other implementations, the UE 102 retains the SDT configuration(s) (e.g., the SDT CU configuration, the SDT DU configuration, and/or the CG-SDT configuration(s)) in response to or after receiving the RRC resume message or transitioning to the connected state. In some implementations, the UE 102 refrains from using the SDT configuration(s) to communicate (e.g., 514 the RRC resume complete message and/or 518 data) with the base station 104, while operating in the connected state. In other implementations, the UE 102 can use the SDT configuration(s) to communicate (e.g., 514 the RRC resume complete message and/or 518 data) with the base station 104, while operating in the connected state. In some implementations, the base station 104 retains the SDT configuration(s) in response to or after causing the UE 102 to transition to the connected state or transmitting the RRC resume message. In some implementations, the base station 104 refrains from using the SDT configuration(s) to communicate (e.g., 514 the RRC resume complete message and/or 518 data) with the UE 102 operating in the connected state. In other implementations, the base station 104 can use the SDT configuration(s) to communicate (e.g., 514 the RRC resume complete message and/or 518 data) with the UE 102 operating in the connected state.

In some implementations, the non-SDT indication message is an RRC message (e.g., a UEAssistanceInformation message or a new RRC message). In such implementations, the UE 102 can continue to perform 518 data communication with the base station 104 after transmitting the non-SDT indication message. In some implementations, the UE 102 transmits a UL MAC PDU, including the non-SDT indication message, to the CU-CP 172A via the DU 174. In some implementations, the UE 102 includes data in the UL MAC PDU in addition to the non-SDT indication message. In other implementations, the UE refrains from including data in the UL MAC PDU.

In some implementations, the UE 102 transmits the non-SDT indication message to the CU-CP 172A via the DU 174 and SRB1. In such implementations, the UE 102 refrains from re-establishing a UE PDCP entity for the SRB1 in response to determining to transmit the non-SDT indication message. The UE 102 generates a UL PDCP PDU including the non-SDT indication message using the UE PDCP entity and transmits 503, 505 the UL PDCP PDU to the CU-CP 172A via the DU 174. Then, the UE 102 uses the UE PDCP entity to receive 512 a DL PDCP PDU including the RRC resume message without re-establishing the UE PDCP entity. The CU-CP 172A uses a CU-CP PDCP entity to receive the 505 the UL PDCP PDU. The CU-CP 172A refrains from re-establishing the CU-CP PDCP entity for the SRB1 in response to receiving the non-SDT indication message. The CU-CP 172A generates the DL PDCP PDU using the CU-CP PDCP entity and transmits 510, 512 the DL PDCP PDU to the UE 102 via the DU 174 and SRB1. The UE 102 generates a UL PDCP PDU including the RRC resume complete message using the UE PDCP entity and transmits 514, 516 the UL PDCP PDU to the CU-CP 172A via the DU 174 and SRB1. The CU-CP 172A receives 514, 516 the UL PDCP PDU from the UE 102 via the DU 174, using the CU-CP PDCP entity. In these implementations, the UE 102 and the CU-CP 172A communicates the PDCP PDUs via the SRB1 without re-establishing the UE PDCP entity and CU-CP PDCP entity.

In other implementations, the non-SDT indication message can be an RRC resume request message (e.g., RRCResumeRequest message or RRCResumeConnectionRequest message). In such implementations, the UE 102 can stop 518 data communication with the base station 104 to transmit the non-SDT indication message. In some implementations, the UE 102 transmits the non-SDT indication message to the CU-CP 172A via the DU 174 and SRB0. In some implementations, the UE 102 re-establishes the UE PDCP entity in response to determining to transmit the non-SDT indication. After re-establishing the UE PDCP entity, the UE 102 receives 512 the DL PDCP PDU using the UE PDCP entity. Similarly, the CU-CP 172A re-establishes the CU-CP PDCP entity upon receiving the non-SDT indication message. After re-establishing the CU-CP PDCP entity, the CU-CP 172A generates the DL PDCP PDU using the CU-CP PDCP entity and transmits 510, 512 the DL PDCP PDU to the UE 102 via the DU 174 and SRB1. After re-establishing the UE PDCP entity, the UE 102 generates a UL PDCP PDU including the RRC resume complete message using the UE PDCP entity and transmits 514, 516 the UL PDCP PDU to the CU-CP 172A via the DU 174 and SRB1. After re-establishing the CU-CP PDCP entity, the CU-CP 172A receives 514, 516 the UL PDCP PDU from the UE 102 via the DU 174, using the CU-CP PDCP entity.

Before performing 592 the small data transmission procedure, the UE 102 operating 502 in the inactive state starts or restarts a first UE CG-SDT timer (e.g., CG-SDT-TAT), as described for FIGS. 3 and 4. In some implementations, the UE 102 can start or restart the first UE CG-SDT timer in response to receiving a timing advance command from the DU 174 during 592 the small data transmission procedure. In some implementations, the UE 102 maintains (e.g., keeps or does not stop, start, or restart) the first UE CG-SDT timer (e.g., CG-SDT-TAT) running in response to or after receiving the RRC resume message. In other implementations, the UE 102 stops the first UE CG-SDT timer in response to or after receiving the RRC resume message.

Similarly, the DU 174 can run a first DU CG-SDT timer for the UE 102 operating 502 in the inactive state, as described for FIGS. 3 and 4. In some implementations, the DU 174 can start or restart the first DU CG-SDT timer in response to transmitting a timing advance command to the UE 102. In some implementations, the DU 174 maintains (e.g., keeps or does not stop, start, or restart) the first DU CG-SDT timer running in response to or after receiving 506 the UE Context Request message, transmitting 508 the UE Context Response message, or transmitting 512 the resume message. In other implementations, the DU 174 stops the first DU CG-SDT timer in response to or after receiving 506 the UE Context Request message, transmitting 508 the UE Context Response message or transmitting 512 the RRC resume message. When the first DU CG-SDT timer expires, the DU 174 can release the CG-SDT configuration(s). Alternatively, when the first DU CG-SDT timer expires, the DU 174 retains the CG-SDT configuration(s) and refrains from receiving or attempting to receive UL transmissions (e.g., MAC PDUs) on the CG resources. In some such implementations, the DU 174 releases the CG resources or determines that the CG resources are not valid.

In some implementations, the UE 102 in the inactive state can run a second UE CG-SDT timer during 592 the small data transmission procedure, as described for the procedure 492. In cases where the second UE CG-SDT timer is running, the UE 102 stops the second UE CG-SDT timer in response to or after receiving 512 the RRC resume message or transitioning 513 to the connected state, in some implementations. Alternatively, the UE 102 maintains the second UE CG-SDT timer in response to or after receiving 512 the RRC resume message or transitioning 513 to the connected state. In some implementations, the UE 102 receives an RRC setup message (e.g., RRCSetup message) instead of the RRC resume message. In response to or after receiving the RRC setup message, the UE 102 stops the second UE CG-SDT timer and transmits an RRC setup complete message to the CU-CP 172A via the DU 174. In other implementations, the UE 102 receives an RRC reject message (e.g., RRCReject message) instead of the RRC resume message. The UE 102 stops the second UE CG-SDT timer in response to or after receiving the RRC reject message.

Similarly, the DU 174 can run a second DU CG-SDT timer during the small data transmission procedure 592. In some implementations, the DU 174 starts or restarts the second DU CG-SDT timer when or after receiving, from the UE 102, a PUSCH transmission on radio resources configured in the CG-SDT configuration. While the second DU CG-SDT timer is running, the DU 174 can transmit a PDCCH using the C-RNTI. In some implementations where the second DU CG-SDT timer is running, the DU 174 stops the second DU CG-SDT timer in response to or after receiving 506 the UE Context Request message, transmitting 508 the UE Context Response message, or transmitting 512 the RRC resume message. In other implementations, the DU 174 maintains the second DU CG-SDT timer in response to or after receiving 506 the UE Context Request message, transmitting 508 the UE Context Response message, or transmitting 512 the RRC resume message. The DU 174 transmits, to the UE 102 operating in the connected state, a DCI on a PDCCH using the C-RNTI agnostic to the second DU CG-SDT timer (e.g., running, expiring, or stopping).

Later in time, the base station 104 can perform a non-SDT configuration procedure 590 and procedure 594 with the UE 102, similar to the procedure 390 and the procedure 394, respectively. The UE 102 transitions 536 to the inactive state in response to receiving an RRC release message in the procedure 594. After transitioning to the inactive state, the UE 102 in the inactive state can perform a small data transmission procedure 593 and an SDT complete procedure 595 with the base station 104, similar to the procedures 492 and 494, respectively.

Referring next to FIG. 5B, a scenario 500B is generally similar to the scenario 500A, except that the UE 102 initiates an RRC resume procedure instead of the small data transmission procedure 592. The differences between the scenarios 500B and 500A are discussed below.

In response to initiating the RRC resume procedure, the UE 102 in the inactive state transmits 542 an RRC resume request message to the DU 174, which in turn transmits 544 an Initial UL RRC Message Transfer message including the RRC resume request message (e.g., an RRCResumeRequest message or an RRCConnectionResumeRequest message) to the CU-CP 172A. In response to receiving the RRC resume request message, the CU-CP 172A determines to cause the UE 102 to transition to the connected state. In response to or after determining to cause the UE 102 to transition to the connected state, the CU-CP 172A transitions the UE to the connected state as described for the scenario 500A.

In some implementations, the UE 102 generates a UL MAC PDU including the RRC resume request message and transmits 542 the UL MAC PDU to the DU 174. In some implementations, the UE 102 transmits 542, to the DU 174, the UL MAC PDU on radio resources configured in a CG configuration for SDT. In other implementations, the UE 102 can perform a random access procedure to transmit the UL MAC PDU, similar to the event 404.

In some implementations, the UE 102 initiates the RRC resume procedure to transmit non-SDT data (i.e., data not qualifying for SDT). More specifically, an upper protocol layer (e.g., NAS layer) of the UE 102 requests an RRC layer (e.g., RRC 214) of the UE 102 to initiate the RRC resume procedure. In other implementations, the UE 102 receives a paging message from the DU 174 and initiates the RRC resume procedure to respond to the paging message. In some implementations, the RRC layer (e.g., RRC 214) initiates the RRC resume procedure in response to the paging message. In yet other implementations, the UE 102 detects that a periodic RAN notification area update (RNAU) timer expires and the UE 102 initiates the RRC resume procedure in response. In some implementations, the RRC layer (e.g., RRC 214) starts or restarts the RNAU timer, maintains the RNAU timer running, and initiates the RRC resume procedure in response to the RNAU timer expiring.

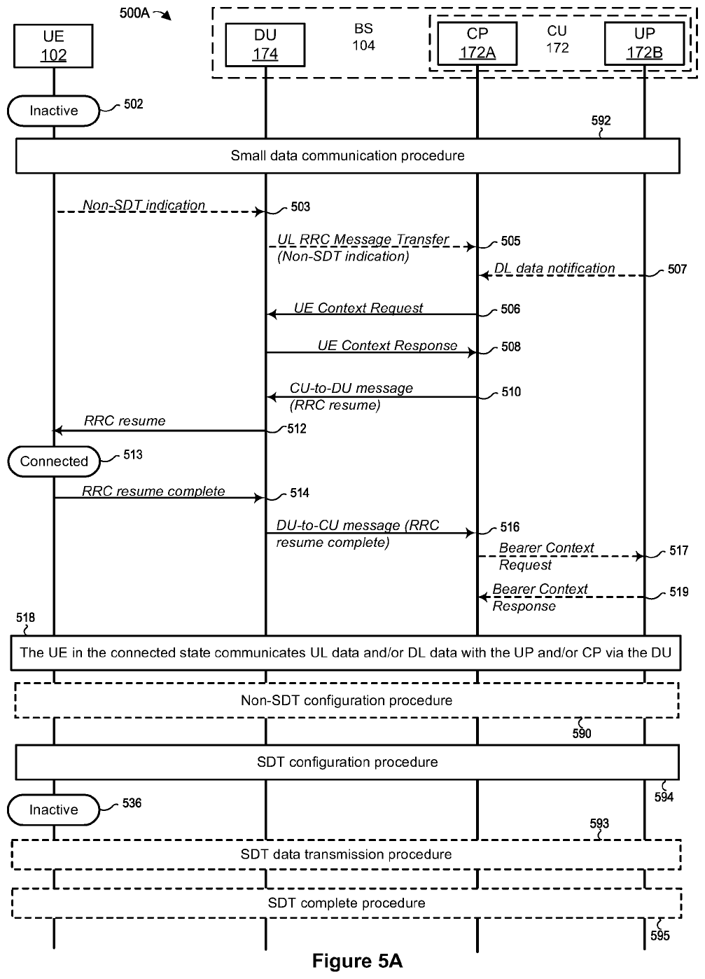

Next, several example methods, that can be implemented in one or more base stations, DUs or CUs or in a RAN to support data communications in the inactive state, are discussed next with reference to FIGS. 6A-18.

FIG. 6A illustrates a method 600A, which can be implemented by a RAN node (e.g., the base station 104, the CU 172, the CU-CP 172A or the DU 174), for delaying an SDT resource request from a UE (e.g., the UE 102).

The method 600A begins at block 602, where the RAN node determines to configure SDT for the UE. At block 604, the RAN node generates an SDT configuration including a delay configuration for delaying an SDT resource request in response to the determination. At block 606, the RAN node transmits a first message (e.g., RRC release message) including an SDT configuration to a UE (see e.g., events 332, 334, 432, 434, 394, 494, 495, 594, 595). At block 608, the RAN node performs data communication with the UE operating in an inactive state, using the SDT configuration (see e.g., events 404, 406, 415, 416, 418, 492, 503, 505, 510, 512, 514, 516, 518, 542, 544, 592).

In some implementations, the SDT configuration configures one or more SDT radio bearers (RBs). The SDT RB(s) include SDT SRB(s) (e.g., SRB1 and/or SRB2) and/or SDT DRB(s). The RAN node configures a particular RB ID for each of the SDT RB(s). For example, the SDT configuration includes an RB list including RB ID(s) of the SDT RB(s). In some implementations, the SDT configuration can include an indication of an SRB2 suitable for SDT. In such cases, the SDT configuration does not include an RB ID for the SRB2. In some implementations, the SDT configuration includes neither an RB ID of the SRB1 nor an indication that the SRB1 is suitable for SDT. In such cases, the SRB1 can be predefined as an SDT RB by default.

In some implementations, the delay configuration is associated with a first SDT RB. In other implementations, the delay configuration is associated with a first logical channel associating with the first SDT RB. When the UE detects data (associated with the first logical channel or the first SDT RB) available for transmission, the UE can trigger transmission of a buffer status report to report a data volume of the data to the RAN node. If the UE has no UL resources for transmitting the data or the buffer status report and is configured with the delay configuration, the UE delays an SDT resource request for requesting UL resources for a predetermined time period. In some implementations, the RAN node can configure the predetermined time period. For example, the RAN node sends a delay timer value specifying the predetermined time period to the UE in the first message. In another example, the RAN node sends a delay timer value specifying the predetermined time period to the UE in another message (see e.g., events 310, 312). In some implementations, the UE starts a delay timer with the delay timer value upon detecting the data available for transmission. While the delay timer is running, the UE refrains from transmitting to the RAN node an SDT resource request for transmitting the buffer status report or the data associated with the first logical channel or first SDT RB. After the delay timer expires, the UE can transmit, to the RAN node, an SDT resource request for transmitting the buffer status report or the data. In some scenarios or implementations, the RAN node does not configure a delay configuration for a (second) SDT RB or a (second) logical channel associating to the second SDT RB. The second SDT RB can be an SDT SRB or an SDT DRB. When the UE detects data (associated with or for the second SDT RB) available for transmission, the UE can trigger transmission of a buffer status report to report a data volume of the data. If the UE has no UL resources for transmitting the buffer status report or the data, the UE transmits an SDT resource request to the RAN node to request that the RAN node provides UL resources. In some implementations, the UE can receive, from the RAN node, delay configuration(s) for other logical channel(s) associating with one or more of the other SDT RB(s). In such cases, the UE can apply the delay configuration(s) as described above.

In other implementations, the delay configuration (i.e., a single delay configuration) applies to all SDT RB(s) (e.g., SDT SRB(s) and/or SDT DRB(s)) configured in the SDT configuration. When the UE detects data (associated with (one or any of) the SDT radio bearer(s)) available for transmission and has no UL resources for transmission of the data, the UE delays an SDT resource request for requesting UL resources to transmit the data for a predetermined time period. In some implementations, the RAN node configures the predetermined time period. For example, the RAN node sends a delay timer value specifying the predetermined time period to the UE in the first message. In another example, the RAN node sends a delay timer value specifying the predetermined time period to the UE in a second message (see e.g., events 310, 312). In yet another example, the delay timer value is a default value (e.g., as defined in a 3GPP specification). In some implementations, the UE starts a delay timer with the delay timer value, upon or when detecting the data available for transmission. While the delay timer is running, the UE refrains from transmitting, to the RAN node, an SDT resource request for transmitting data associated with the SDT RB(s). After the delay timer expires, the UE can transmit, to the RAN node, an SDT resource request for transmitting the data.

In some implementations, the SDT SRB(s) includes SRB0, SRB1, and/or SRB2. In some implementations, the delay configuration does not apply to the SRB0. In such implementations, when the UE in the inactive state has a UL RRC message (e.g., an RRC resume request message) to transmit on the SRB0, the UE can transmit, to the RAN node, an SDT resource request to transmit the UL RRC message. In other implementations, the delay configuration applies to the SRB0. In such implementations, when the UE in the inactive state has a UL RRC message (e.g., an RRC resume request message) to transmit on the SRB0, the UE delays transmission or initiation of an SDT resource request to the RAN node. In some implementations, the delay configuration does not apply to the SRB1. In such implementations, when the UE in the inactive state has a UL RRC message (e.g., a non-SDT indication message or a UE assistance information message) to transmit on SRB1, the UE can initiate or transmit an SDT resource request to the RAN node. In other implementations, the delay configuration applies to the SRB1. In such implementations, when the UE in the inactive state has a UL RRC message (e.g., non-SDT indication message or a UE assistance information message) to transmit on the SRB0, the UE delays transmission or initiation of an SDT resource request to the RAN node.

In cases where the RAN node is a CU (e.g., the CU 172 or CU-CP 172A), the CU generates the SDT configuration (e.g., SDT CU configuration). In some implementations, the CU obtains the delay configuration and/or the delay timer value from a DU. For example, the CU can receive at least one DU-to-CU message including the delay configuration and/or the delay timer value from the DU (see, e.g., events 308, 330, 430).

In cases where the delay configuration is associated with a logical channel, the DU can include a logical channel identity (LCID) of the logical channel in the delay configuration. Alternatively, the DU can generate a container IE (e.g., logical channel configuration, a non-SDT DU configuration, an SDT DU configuration, a CG configuration, or a CG-SDT configuration) including the delay configuration and the LCID, and include the container IE in the DU-to-CU message. The CU can include the container IE and/or the delay timer value in the first message or the second message. Alternatively, the delay configuration includes a bitmap where a bit corresponds to a particular RB ID in the RB list. The DU can set each bit to one of two values (i.e., 0 or 1). One of the two values for a bit in the bitmap (e.g., value 1) indicates that the UE delays an SDT resource request for a corresponding RB ID in the RB list. The other value for the bit (e.g., value 0) indicates that the corresponding RB ID in the RB list indicates that the UE is allowed to transmit an SDT resource request for the corresponding RB ID in the RB list. For example, the RB list includes RB IDs 1, . . . , N, where N is a positive integer. The delay configuration can include a bitmap of bits 1, . . . , N for RB IDs 1, . . . , N respectively. To configure the UE to delay an SDT resource request for transmission of data associated with RB ID X (1<=X<=N), the DU can set the bit X to value 1. Thus, the UE can determine whether to delay transmission or initiation of an SDT resource request for an SDT RB in accordance with a corresponding bit in the bitmap. In cases where the SRB2 is an SDT RB, the DU in some implementations can include, in the DU-to-CU message, a delay configuration for the SRB2. The CU includes the delay configuration specific for the SRB2 in the SDT configuration. Thus, the UE can determine whether to delay transmission or initiation of an SDT resource request for the SRB2 in accordance with the SRB2-specific delay configuration. Alternatively, the DU does not configure a delay configuration for the SRB2.

In other implementations, the CU generates the delay configuration and/or the delay timer value instead of the DU. In cases where the delay configuration is associated with a particular logical channel where a particular SDT RB associates, the CU generates a container IE including the LCID of the logical channel and the delay configuration, and includes the container IE in the SDT configuration. In cases where the delay configuration is associated with a particular SDT RB, the CU generates a container IE including an RB ID for the SDT RB and the delay configuration, and includes the container IE in the SDT configuration. Alternatively, the CU includes the RB ID for the SDT RB in the delay configuration. In further implementations, the delay configuration includes a bitmap where a bit corresponds to a particular RB ID in the RB list. The CU can set each bit to one of two values (i.e., 0 or 1). One of the two values for a bit in the bitmap indicates that the UE delays an SDT resource request for a corresponding RB ID in the RB list. The other value for the bit indicates that the corresponding RB ID in the RB list indicates that the UE is allowed to transmit an SDT resource request for the corresponding RB ID in the RB list. For example, the RB list includes RB IDs 1, . . . , N, where N is a positive integer. The delay configuration can include a bitmap of bits 1, . . . , N for RB IDs 1, . . . , N respectively. In cases where the SRB2 is an SDT RB, the CU, in some implementations, includes a delay configuration specific for the SRB2 in the SDT configuration. That is, the delay configuration can be specific to the SDT SRB2. Alternatively, the DU does not configure a delay configuration for the SDT SRB2.

In some implementations, the SDT resource request is a random access preamble of a four-step random access procedure or a MsgA of a two-step random access procedure. In other implementations, the SDT resource request is a two-step random access procedure or a two-step random access procedure. In such implementations, “transmit an SDT source request” can be replaced with “initiate an SDT resource request”.

After the predetermined time period passes or the delay timer expires, the UE can initiate the four-step random access procedure for transmitting the data associated with the first logical channel or the first SDT RB. In response to the initiation, the UE transmits a random access preamble to the RAN node. In response to receiving the random access preamble, the RAN node transmits, to the UE, a random access response (RAR) including an uplink grant, a temporary C-RNTI and a timing advance command, and the UE 102 transmits, to the RAN node, a UL MAC PDU, including the data or a portion of the data, in accordance with the uplink grant. In some implementations, the UE includes a buffer status report and/or a C-RNTI of the UE in the UL MAC PDU. The RAN node receives the UL MAC PDU in accordance with the uplink grant in the RAR. In response to receiving the UL MAC PDU, the RAN node can transmit a DCI on a PDCCH using the C-RNTI. More specifically, the RAN node generates a DCI and a CRC of the DCI, scrambles the CRC with the C-RNTI, and transmits the DCI and scrambled CRC on a PDCCH. After transmitting the UL MAC PDU, the UE monitors a PDCCH using the C-RNTI. When the UE receives the DCI and scrambled CRC on the PDCCH, the UE verifies the scrambled CRC using the DCI and the C-RNTI. If the UE verifies that the CRC is correct, the UE determines that a contention resolution for the four-step random access procedure succeeds.

Further, after the predetermined time period passes or the delay timer expires, the UE can initiate the two-step random access procedure for transmitting the data associated with the first logical channel or the first SDT RB. In response to the initiation, the UE transmits an MsgA, including a random access preamble and the UL MAC PDU, to the RAN node in accordance with two-step random access configuration parameters. In response to receiving the UL MAC PDU, the RAN node can transmit a DCI on a PDCCH using the C-RNTI. More specifically, the RAN node generates a DCI and a CRC of the DCI, scrambles the CRC with the C-RNTI, and transmits the DCI and scrambled CRC on a PDCCH. After transmitting the UL MAC PDU, the UE attempts to receive a PDCCH using the C-RNTI. When the UE receives the DCI and scrambled CRC, the UE verifies the scrambled CRC using the DCI and the C-RNTI. If the UE verifies that the CRC is correct, the UE determines that a contention resolution for the two-step random access procedure succeeds.

FIG. 6B is a flow diagram of an example method 600B, similar to the method 600A, except that method 600B includes blocks 603 and 605. At block 603, the RAN node determines whether the SDT is a CG-SDT. If the RAN node determines to configure the CG-SDT for the UE, the flow proceeds to block 604 as described above with regard to FIG. 6A. If the RAN node determines to configure the RA-SDT for the UE, the flow proceeds to block 605. At block 605, the RAN node generates an SDT configuration excluding a delay configuration for delaying an SDT resource request in response to the determination.

FIG. 6C is a flow diagram of an example method 600C, similar to the methods 600A and 600B, except that method 600C includes block 613. At block 613, the RAN node determines whether to configure a delay configuration for an SDT radio bearer (RB). If the RAN node determines to configure a delay configuration for the SDT RB, the flow proceeds to block 604 as described above with regard to FIG. 6A. If the RAN node determines not to configure a delay configuration for the SDT RB, the flow proceeds to block 605 as described above with regard to FIG. 6B.

In some implementations, the RAN node determines whether to configure a delay configuration for an SDT RB in accordance with one or more QoS parameters for the SDT RB. For example, if the QoS parameter(s) requires a particular latency, the RAN node determines not to configure a delay configuration for the SDT RB. Otherwise, the RAN node determines to configure a delay configuration for the SDT RB.

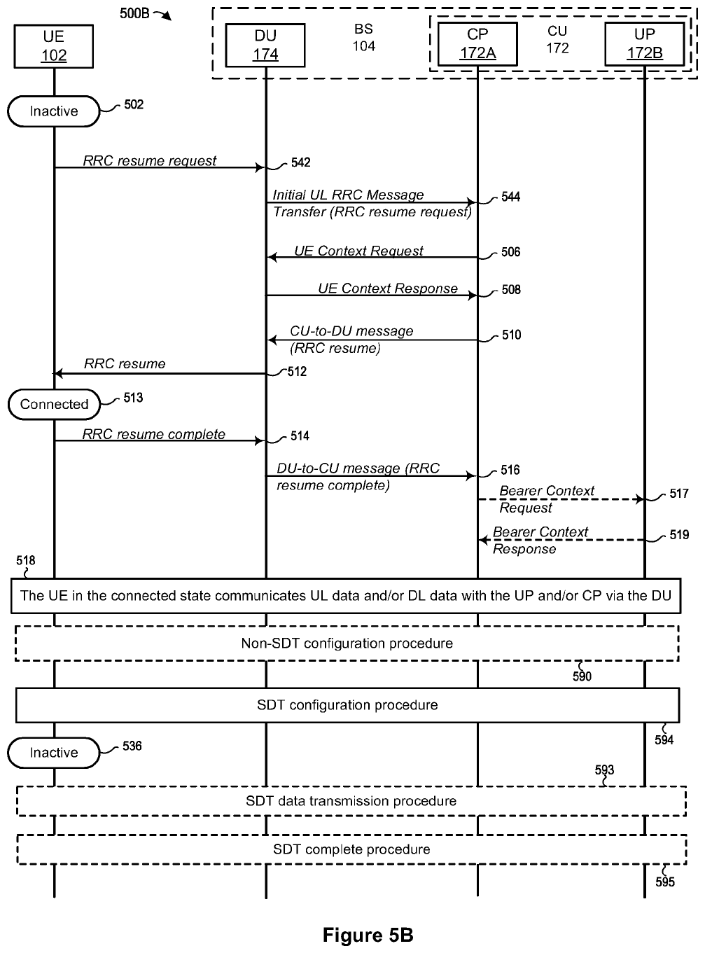

FIG. 7 illustrates a method 700, which can be implemented by a DU (e.g., the DU 174), for delaying an SDT resource request from a UE (e.g., the UE 102).

The method 700 begins at block 702, where the DU receives, from a CU, a CU-to-DU message for configuring SDT for a UE (e.g., events 328, 394, 428, 494, 495, 594, 595). At block 704, the DU generates a delay configuration for delaying an SDT resource request from the UE. At block 706, the DU transmits a DU-to-CU message including the delay configuration to the CU (e.g., events 330, 394, 430, 494, 495, 594, 595). At block 708, the DU transmits an RRC release message including the delay configuration to the UE. Examples and implementations for FIG. 6A can apply to FIG. 7.

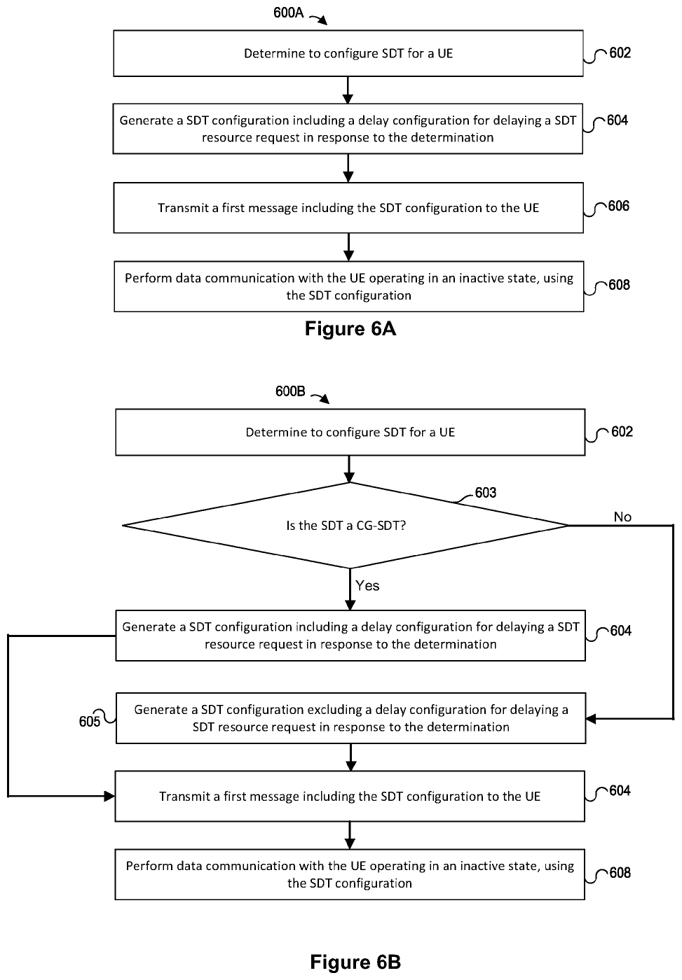

FIG. 8 illustrates a method 800, which can be implemented by a DU (e.g., the DU 174), for delaying a resource request from a UE (e.g., the UE 102).

The method 800 begins at block 802, where the DU receives, from a CU, a CU-to-DU message to request lower configurations for a UE (see e.g., events 306, 328, 394, 428, 494, 495, 594, 595). At block 804, the DU determines whether the CU-to-DU message requests lower configurations for SDT. If the DU at block 804 determines that the CU-to-DU message requests lower configurations for SDT, the flow proceeds to block 806. At block 806, the DU generates a first delay configuration for the UE. At block 808, the DU transmits a DU-to-CU message, including the first delay configuration, to the CU (see e.g., events 330, 394, 430, 494, 495, 594, 595). If the DU at block 804 determines that the CU-to-DU message requests lower configurations for non-SDT operations, the flow proceeds to block 810. At block 810, the DU generates a second delay configuration for the UE. At block 812, the DU transmits a DU-to-CU message including the second delay configuration to the CU (see e.g., event 308).

In some implementations, the first delay configuration is similar to the delay configuration described for FIG. 6A, and examples and implementations for FIG. 6A can apply to FIG. 8. In some implementations, the second delay configuration is specific for or associated with an RB or a logical channel associating with the RB. In some implementations, the UE applies the first delay configuration during SDT, while operating in an inactive state and the UE applies the second delay configuration during data communication with the RAN node, while operating in a connected state. For example, the second delay configuration can be a logicalChannelSR-DelayTimerApplied. In some such implementations, the DU generates a logical channel configuration (e.g., LogicalChannelConfig) including the second delay configuration and an LCID for the logical channel, and further generates an RLC bearer configuration (e.g., RLC-BearerConfig), including the logical channel configuration and an RB ID of the RB. Then, the DU includes the RLC bearer configuration in a cell group configuration (e.g., CellGroupConfig). The DU at block 812 transmits the DU-to-CU message, including the cell group configuration to the CU.

In some scenarios or implementations, when the UE in the connected state detects data (e.g., associated with the RB or logical channel) available for transmission, the UE can trigger transmission of a buffer status report to report a data volume of the data. If the UE has no UL resources for transmission of the data or buffer status report, the UE in the connected state delays transmission of an SDT resource request for requesting UL resources to transmit the data for a predetermined time period. In some implementations, the UE in the connected state starts a delay timer with a delay timer value to delay the SDT resource request in response to the triggering. While the delay timer is running, the UE in the connected state refrains from transmitting or initiating to the DU a non-SDT resource request for transmitting the buffer status report or the data. After the delay timer expires, the UE in the connected state can initiate or transmit a non-SDT resource request for transmitting the buffer status report or the data. In some implementations, the non-SDT resource request includes a scheduling request procedure, a four-step random access procedure, or a two-step random access procedure. In some implementations, the non-SDT request is a dedicated scheduling request on a PUCCH, a random access preamble of a four-step random access procedure, or an MsgA of a two-step random access procedure.

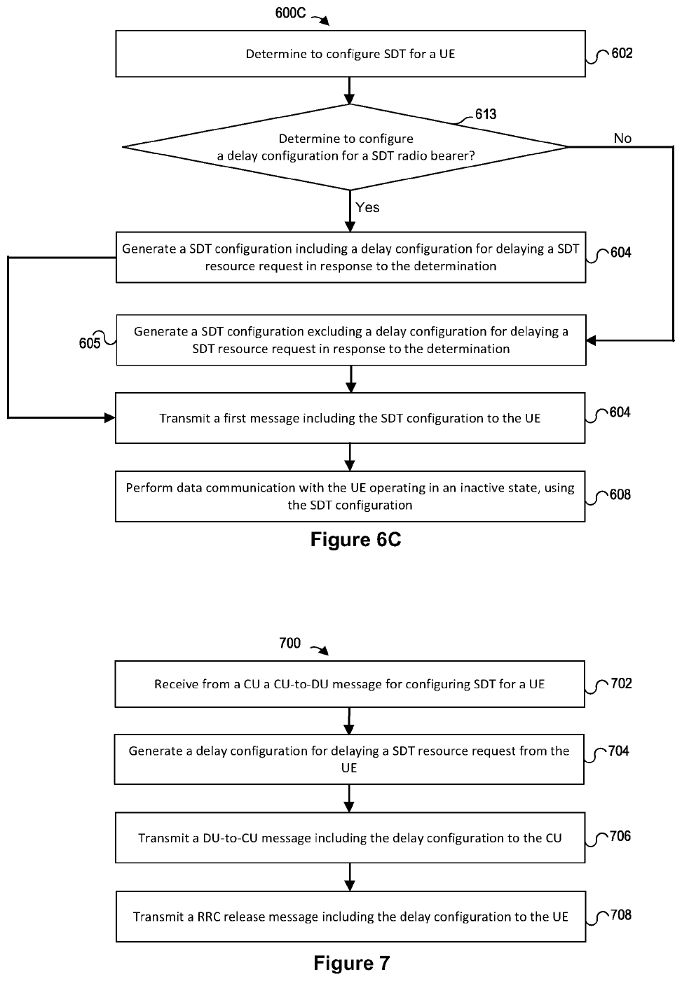

FIG. 9 illustrates a method 900, which can be implemented by a RAN node (e.g., the base station 104, the CU 172, the CU-CP 172A, or the DU 174), for delaying resource requests from a UE (e.g., the UE 102).

The method 900 begins at block 902, where the RAN node communicates with the UE (e.g., events 304, 390). At block 904, the RAN node determines to configure the UE to delay an SDT resource request. At block 906, the RAN node transmits a first delay configuration to the UE in response to the determination at block 904 (see e.g., event 332, 334, 394, 432, 434, 494. 495, 595, 595). At block 908, the RAN node determines to configure the UE to delay a non-SDT resource request. At block 910, the RAN node transmits a second delay configuration to the UE in response to the determination at block 908 (see e.g., event 310, 312).

Examples and implementations for the first and second delay configurations are similar to the first and second delay configurations described for FIG. 8.

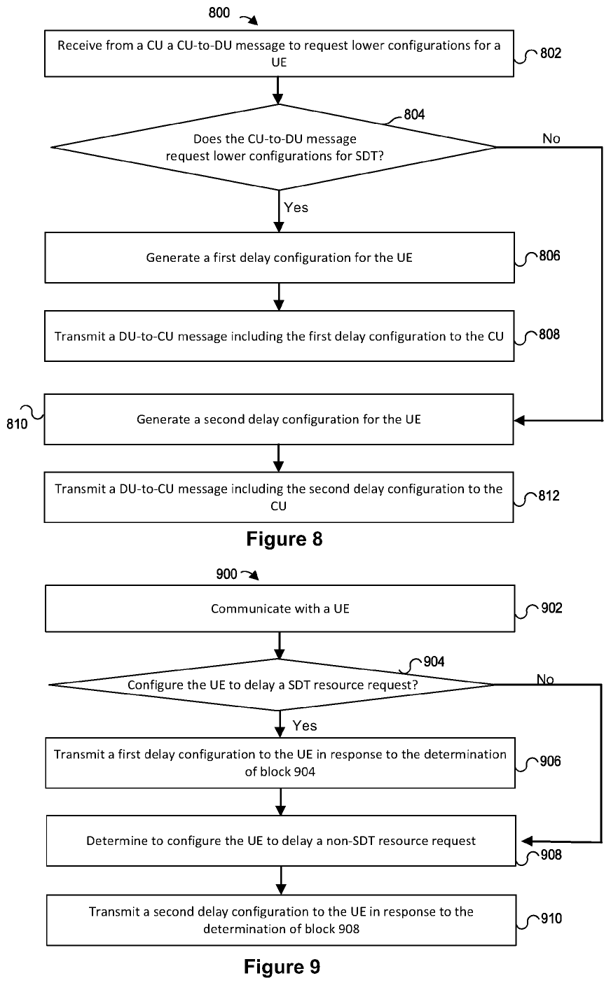

FIG. 10 illustrates a method 1000, which can be implemented by a RAN node (e.g., the RAN 105, base station 104, CU 172, CU-CP 172A, or DU 174), for delaying a resource request from a UE (e.g., the UE 102).

The method 1000 begins at block 1002, where the RAN node communicates with the UE (e.g., events 304, 390, 404, 406, 418, 420, 492, 493, 592, 593). At block 1004, the RAN node determines to configure the UE to delay a resource request. At block 1006, the RAN node determines whether the resource request is for SDT or non-SDT operations. If the RAN node at block 1006 determines that the resource request is for SDT (i.e., the RAN node determines to delay a resource request for SDT), the flow proceeds to block 1008. At block 1008, the RAN node transmits a first delay configuration to the UE (see e.g., event 332, 334, 394, 432, 434, 494. 495, 595, 595). If the RAN node at block 1006 determines that the resource request is for non-SDT operations (i.e., the RAN node determines to delay a resource request for non-SDT), the flow proceeds to block 1010. At block 1010, the RAN node transmits a second delay configuration to the UE (see e.g., event 310, 312).

Examples and implementations for the first and second delay configurations are similar to the first and second delay configurations described for FIG. 8.

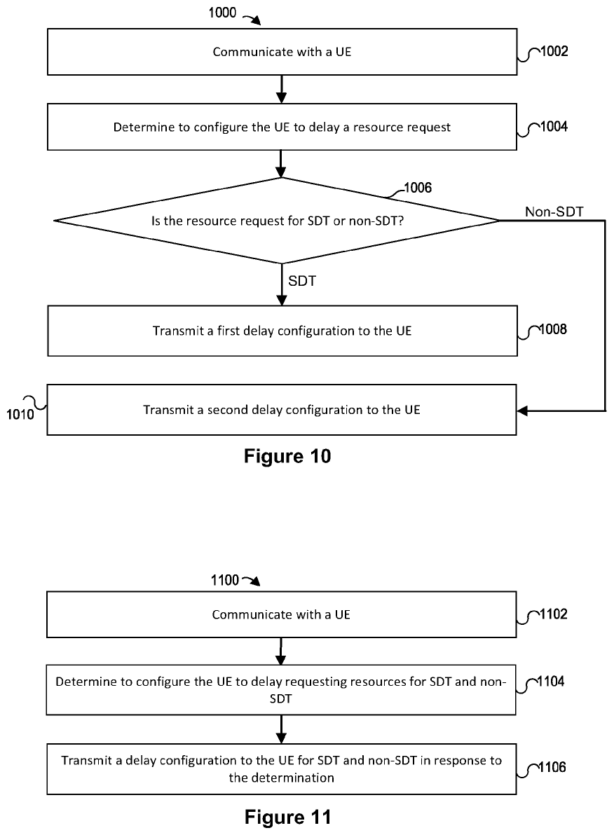

FIG. 11 illustrates a method 1100, which can be implemented by a RAN node (e.g., the RAN 105, base station 104, CU 172, CU-CP 172A, or DU 174), for delaying resource requests from a UE (e.g., the UE 102).

The method 1100 begins at block 1102, where the RAN node communicates with the UE (e.g., events 304, 390, 404, 406, 418, 420, 492, 493, 592, 593). At block 1104, the RAN node determines to configure the UE to delay requesting resources for SDT and non-SDT. At block 1106, the RAN node transmits a delay configuration to the UE for SDT and non-SDT in response to the determination (see e.g., events 310, 312).

In some implementations, the delay configuration is similar to the second delay configuration described above. The UE in the connected state receives the delay configuration and applies the delay configuration. After transitioning to an inactive state from the connected state, the UE in the inactive state applies the delay configuration in a similar way as described for the first delay configuration.

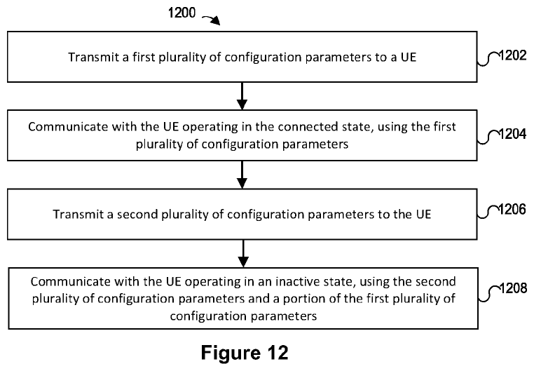

FIG. 12 illustrates a method 1200, which can be implemented by a RAN node (e.g., the RAN 105, base station 104, CU 172, CU-CP 172A, or DU 174), for delaying resource requests from a UE (e.g., the UE 102).

The method 1200 begins at block 1202, where the RAN node transmits a first plurality of configuration parameters to the UE (see e.g., events 310, 312, 390, 510, 512). At block 1204, the RAN node communicates with the UE operating in the connected state, using the first plurality of configuration parameters (see e.g., events 318, 320, 514, 516, 518). At block 1206, the RAN node transmits a second plurality of configuration parameters to the UE (see e.g., 332, 334, 394, 432, 434, 494, 495, 594, 595). At block 1208, the RAN node communicates with the UE operating in an inactive state, using the second plurality of configuration parameters and a portion of the first plurality of configuration parameters (see, e.g., events 404, 406, 418, 420, 432, 434, 492, 493, 592, 593).

In some implementations, the RAN node at block 1202 transmits at least one RRC message (e.g., an RRC reconfiguration message and/or RRC resume message) including the first plurality of configuration parameters to the UE. The RAN node can receive an RRC reconfiguration complete message from the UE in response to each of the RRC reconfiguration messages. For example, the RRC messages include RRC configuration(s), such as cell group configuration(s) (e.g., CellGroupConfig IE(s)), measurement configuration(s) (e.g., MeasConfig IE(s)), and/or radio bearer configuration(s) (e.g., RadioBearerConfig IE(s)), including the first plurality of configuration parameters. The cell group configuration(s) includes RLC bearer configuration(s) including RLC configuration parameters and logical channel configuration(s) (e.g., LogicalChannelConfig IE(s)) for RB(s) configured in the radio bearer configuration(s). In some implementations, one or more of the logical channel configuration(s) includes a delay configuration (e.g., logicalChannelSR-DelayTimerApplied)

In some implementations, the RAN node transmits at least one RRC release message including the second plurality of configuration parameters to the UE. In some implementations, each of the at least one RRC release message includes (a portion of) the second plurality of configuration parameters. For example, the at least one RRC release message includes SDT configuration(s) (e.g., SDT-Config IE(s)) including the second plurality of configuration parameters. In some implementations, the SDT configuration(s) includes SDT DRB list(s), SDT SRB2 indication(s), SDT-MAC-PHY-Config, SDT-MAC-PHY-CG-Config, an SDT session timer value, and/or an SDT data volume threshold value. In some implementations, the second plurality of configuration parameters may not include a delay configuration. In other implementations, the second plurality of configuration parameters includes a delay configuration as described above.

In some implementations, the portion of the first plurality of configuration parameters includes configuration parameters in the radio bearer configuration(s). In some implementations, the portion of the first plurality of configuration parameters at block 1208 includes configuration parameters in the cell group configuration(s), RLC bearer configuration(s) and/or logical channel configuration(s).

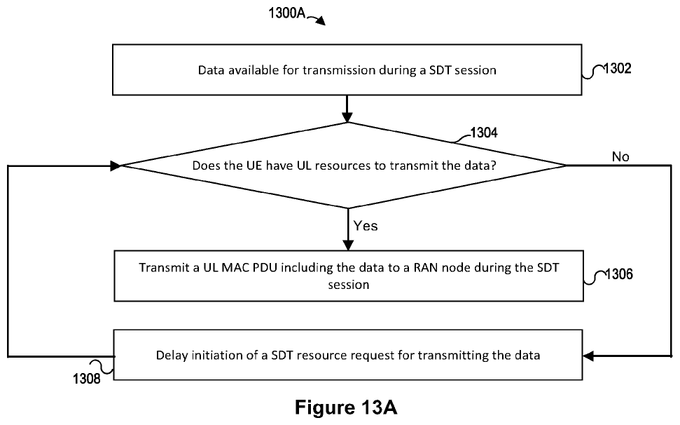

FIG. 13A illustrates a method 1300A, which can be implemented by a UE (e.g., the UE 102), for managing data transmission while the UE operates in an inactive state.

The method 1300A begins at block 1302, where the UE determines data available for transmission during an SDT session. At block 1304, the UE determines whether the UE has UL resources to transmit the data. If the UE at block 1304 determines that the UE has UL resources to transmit the data, the flow proceeds to block 1306. At block 1306, the UE transmits a UL MAC PDU including the data to a first RAN node (e.g., the base station 104 or DU 174A of the base station 104) during the SDT session (see e.g., events 418, 420, 492, 493, 592, 593). If the UE at block 1304 determines that the UE has no UL resources to transmit the data, the flow proceeds to block 1308. At block 1308, the UE delays initiation (e.g., transmission) of an SDT resource request for transmitting the data. That is, the UE refrains from initiating an SDT resource request for transmitting the data.

Before performing or initiating the SDT session, the UE receives a first message (e.g., RRC release message) including an SDT configuration from the first RAN node or a second RAN node (e.g., the base station 106, DU 174 of the base station 106, or DU 174B of the base station 104) (see e.g., events 332, 334, 394, 432, 434, 494, 495, 594, 595). The UE transitions to or remains in an inactive state in response to the RRC release message or SDT configuration (see e.g., events 336, 402, 436). Then the UE initiates or performs the SDT session with the first RAN node in accordance with the SDT configuration (see e.g., events 404, 492, 493, 592, 593).

In some implementations, the SDT configuration configures one or more SDT radio bearers (RBs). The SDT RB(s) include SDT SRB(s) (e.g., SRB1 and/or SRB2) and/or SDT DRB(s). The RAN node (i.e., the first or second RAN node) configures a particular RB ID for each of the SDT RB(s). For example, the SDT configuration includes an RB list including RB ID(s) of the SDT RB(s). In some implementations, the SDT configuration can include an indication indicating the SRB2 suitable for SDT. In such cases, the SDT configuration does not include an RB ID of the SRB2. In some implementations, the SDT configuration includes neither an RB ID of the SRB1 nor an indication that the SRB1 is suitable for SDT. In such cases, the SRB1 can be predefined as an SDT RB by default. In some implementations, the SDT configuration includes a delay configuration. In other implementations, the UE receives a delay configuration in another message (see e.g., events 310, 312, 390).

In some implementations, the delay configuration is associated with a first SDT RB. In other implementations, the delay configuration is associated with a first logical channel associating with the first SDT RB. When the UE at block 1302 detects the data (associated with the first logical channel or the first SDT RB) available for transmission, the UE can trigger transmission of a buffer status report to report data volume of the data to the RAN node. If the UE has no UL resources for transmitting the data or the buffer status report, the UE delays an SDT resource request for requesting UL resources for a predetermined time period. In some implementations, the RAN node configures the predetermined time period. For example, the RAN node can send a delay timer value specifying the predetermined time period to the UE in the first message. In another example, the RAN node can send a delay timer value specifying the predetermined time period to the UE in a second message (see e.g., events 310, 312, 390). In some implementations, the UE starts a delay timer with the delay timer value, upon or when detecting the data available for transmission. While the delay timer is running, the UE refrains from transmitting, to the first RAN node, an SDT resource request for transmitting the buffer status report or the data associated with the first logical channel or first SDT RB. After the delay timer expires, the UE can transmit, to the first RAN node, an SDT resource request for transmitting the buffer status report or the data. In some implementations, the RAN node does not configure a delay configuration for a (second) SDT RB or a (second) logical channel associating with the second SDT RB. The second SDT RB can be an SDT SRB or an SDT DRB. When the UE detects data (associated with or for the second SDT RB) available for transmission, the UE can trigger transmission of a buffer status report to report a data volume of the data. If the UE has no UL resources for transmitting the buffer status report or the data, the UE transmits an SDT resource request to the first RAN node to request the first RAN node to provide UL resources.

In other implementations, the delay configuration applies to all SDT RB(s) (e.g., SDT SRB(s) and/or SDT DRB(s)) configured with the SDT configuration. When the UE detects data (associated with any of the SDT radio bearer(s)) available for transmission and has no UL resources for transmission of the data, the UE delays an SDT resource request for requesting UL resources to transmit the data for a predetermined time period. In some implementations, the RAN node configures the predetermined time period. For example, the RAN node can send a delay timer value specifying the predetermined time period to the UE in the first message. In another example, the RAN node can send a delay timer value specifying the predetermined time period to the UE in a second message (see e.g., events 310, 312, 390). In yet another example, the delay timer value can be a default value (e.g., as defined in a 3GPP specification). In some implementations, the UE starts a delay timer with the delay timer value upon detecting the data available for transmission. While the delay timer is running, the UE refrains from transmitting, to the first RAN node, an SDT resource request for transmitting data associated with any of the SDT RB(s). After the delay timer expires, the UE can transmit, to the first RAN node, an SDT resource request for transmitting the data.

In some implementations, the SDT SRB(s) includes SRB0, SRB1, and/or SRB2. In some implementations, the delay configuration does not apply to the SRB0. In such implementations, when the UE in the inactive state has a UL RRC message (e.g., an RRC resume request message) to transmit on the SRB0, the UE can transmit to the first RAN node an SDT resource request to transmit the UL RRC message. In other implementations, the delay configuration applies to the SRB0. In such implementations, when the UE in the inactive state has a UL RRC message (e.g., an RRC resume request message) to transmit on the SRB0, the UE delays transmission or initiation of an SDT resource request to the first RAN node. In some implementations, the delay configuration does not apply to the SRB1. In such implementations, when the UE in the inactive state has a UL RRC message (e.g., a non-SDT indication message or a UE assistance information message) to transmit on the SRB1, the UE can initiate or transmit an SDT resource request to the first RAN node. In other implementations, the delay configuration applies to the SRB1. In such implementations, when the UE in the inactive state has a UL RRC message (e.g., non-SDT indication message or a UE assistance information message) to transmit on the SRB0, the UE delays transmission or initiation of an SDT resource request to the RAN node.

In cases where the RAN node is a CU (e.g., the CU 172 or CU-CP 172A), the CU generates the SDT configuration (e.g., SDT CU configuration). In some implementations, the CU can obtain the delay configuration and/or the delay timer value from a DU. For example, the CU can receive at least one DU-to-CU message including the delay configuration and/or the delay timer value from the DU (see, e.g., events 308, 330, 430).

In cases where the delay configuration is associated with a logical channel, the DU can include a logical channel identity (LCID) for the logical channel in the delay configuration. Alternatively, the DU can generate a container IE (e.g., logical channel configuration, a non-SDT DU configuration, an SDT DU configuration, a CG configuration, or a CG-SDT configuration) including the delay configuration and the LCID, and include the container IE in the DU-to-CU message. The CU can include the container IE and/or the delay timer value in the first message or the second message. Yet alternatively, the delay configuration includes a bitmap where a bit corresponds to a particular RB ID in the RB list. The DU can set each bit to one of two values (i.e., 0 or 1). One of the two values for a bit in the bitmap (e.g., value 1) indicates that the UE delays an SDT resource request for a corresponding RB ID in the RB list. The other value for the bit (e.g., value 0) indicates that the corresponding RB ID in the RB list indicates that the UE is allowed to transmit an SDT resource request for the corresponding RB ID in the RB list. For example, the RB list includes RB IDs 1, . . . , N, where N is a positive integer. The delay configuration can include a bitmap of bits 1, . . . , N for RB IDs 1, . . . , N respectively. To configure the UE to delay an SDT resource request for transmission of data associated with RB ID X (1<=X<=N), the DU can set the bit X to value 1. Thus, the UE can determine whether to delay transmission or initiation of an SDT resource request for an SDT RB in accordance with a corresponding bit in the bitmap. In cases where the SRB2 is an SDT RB, the DU in some implementations can include, in the DU-to-CU message, a delay configuration for the SRB2. The CU includes the delay configuration specific for SRB2 in the SDT configuration. Thus, the UE can determine whether to delay transmission or initiation of an SDT resource request for the SRB2 in accordance with the SRB2-specific delay configuration. Alternatively, the DU does not configure a delay configuration for the SRB2.

In other implementations, the CU generates the delay configuration and/or the delay timer value instead of the DU. In cases where the delay configuration is associated with a particular logical channel with which a particular SDT RB is associated, the CU generates a container IE including the LCID for the logical channel and the delay configuration, and includes the container IE in the SDT configuration. In cases where the delay configuration is associated with a particular SDT RB, the CU generates a container IE including an RB ID of the SDT RB and the delay configuration, and includes the container IE in the SDT configuration. Alternatively, the CU includes the RB ID of the SDT RB in the delay configuration. Alternatively, the delay configuration includes a bitmap where a bit corresponds to a particular RB ID in the RB list. The CU can set each bit to one of two values (i.e., 0 or 1). One of the two values for a bit in the bitmap indicates that the UE delays an SDT resource request for a corresponding RB ID in the RB list. The other value for the bit indicates that the corresponding RB ID in the RB list indicates that the UE is allowed to transmit an SDT resource request for the corresponding RB ID in the RB list. For example, the RB list includes RB IDs 1, . . . , N, where N is a positive integer. The delay configuration can include a bitmap of bits 1, . . . , N for RB IDs 1, . . . , N respectively. Thus, the UE can determine whether to delay transmission or initiation of an SDT resource request for an SDT RB in accordance with a corresponding bit in the bitmap. In cases where the SRB2 is an SDT RB, the CU in some implementations includes a delay configuration specific for the SRB2 in the SDT configuration. Thus, the UE can determine whether to delay transmission or initiation of an SDT resource request for the SRB2 in accordance with the SRB2-specific delay configuration. Alternatively, the DU does not configure a delay configuration for the SRB2.

In some implementations, the SDT resource request can be a random access preamble of a four-step random access procedure or a MsgA of a two-step random access procedure. In other implementations, the SDT resource request can be a two-step random access procedure. In such implementations, “transmit an SDT source request” can be replaced with “initiate an SDT resource request”.

After the predetermined time period passes or the delay timer expires, the UE can initiate the four-step random access procedure for transmitting the data associated with the first logical channel or the first SDT RB. In response to the initiation, the UE transmits a random access preamble to the RAN node. In response to the random access preamble, the RAN node transmits, to the UE, a random access response (RAR) including an uplink grant, a temporary C-RNTI, and a timing advance command, and the UE 102 transmits, to the RAN node, a UL MAC PDU, including the data or a portion of the data, in accordance with the uplink grant. In some implementations, the UE includes a buffer status report and/or a C-RNTI of the UE in the UL MAC PDU. The RAN node receives the UL MAC PDU in accordance with the uplink grant in the RAR. In response to receiving the UL MAC PDU, the RAN node can transmit a DCI on a PDCCH using the C-RNTI. More specifically, the RAN node generates a DCI and a CRC of the DCI, scrambles the CRC with the C-RNTI and transmits the DCI and scrambled CRC on a PDCCH. After transmitting the UL MAC PDU, the UE monitors a PDCCH using the C-RNTI. When the UE receives the DCI and scrambled CRC on the PDCCH, the UE verifies the scrambled CRC using the DCI and the C-RNTI. If the UE verifies that the CRC is correct, the UE determines that a contention resolution for the four-step random access procedure succeeds.

After the predetermined time period passes or the delay timer expires, the UE can initiate the two-step random access procedure for transmitting the data associated with the first logical channel or the first SDT RB. In response to the initiation, the UE transmits an MsgA, including a random access preamble and the UL MAC PDU, to the RAN node in accordance with two-step random access configuration parameters. In response to receiving the UL MAC PDU, the RAN node can transmit a DCI on a PDCCH using the C-RNTI. More specifically, the RAN node generates a DCI and a CRC for the DCI, scrambles the CRC with the C-RNTI and transmits the DCI and scrambled CRC on a PDCCH. After transmitting the UL MAC PDU, the UE attempts to receive a PDCCH using the C-RNTI. When the UE receives the DCI and scrambled CRC, the UE verifies the scrambled CRC using the DCI and the C-RNTI. If the UE verifies that the CRC is correct, the UE determines that a contention resolution for the two-step random access procedure succeeds.

FIG. 13B is a flow diagram of an example method 1300B, similar to the method 1300A, except that method 1300B includes blocks 1307 and 1310. At block 1307, the UE determines whether the UE is configured to delay an SDT resource request. If the UE at block 1307 determines that the UE is configured to delay an SDT resource request, the flow proceeds to block 1308 as described with regard to FIG. 13A above. Otherwise, if the UE at block 1307 determines that the UE is not configured to delay an SDT resource request, the flow proceeds to block 1310. At block 1310, the UE initiates an SDT resource request for transmitting the data. That is, the UE at block 1310 transmits to the RAN node (i.e., the first RAN node) an SDT resource request to request that the RAN node schedule UL resources for the UE to transmit the data.

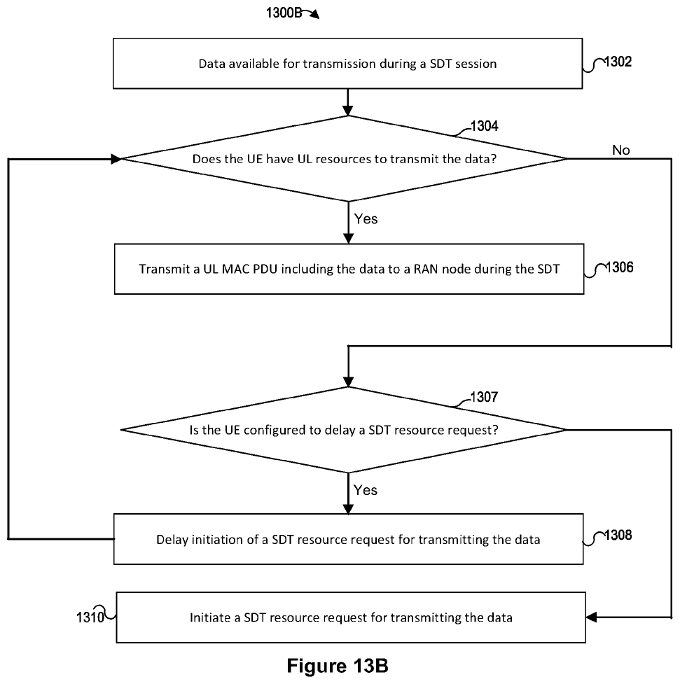

FIG. 14A illustrates a method 1400A, which can be implemented by a UE (e.g., the UE 102), for managing data transmission while the UE operates in an inactive state.

The method 1400A begins at block 1402, where the UE determines to transmit a MAC control element during an SDT session. At block 1404, the UE determines whether the UE has UL resources to transmit the MAC control element. If the UE at block 1404 determines that the UE has UL resources to transmit the MAC control element, the flow proceeds to block 1406. At block 1406, the UE transmits a UL MAC PDU including the MAC control element to a first RAN node (e.g., the base station 104 or DU 174A of the base station 104) during the SDT session (see e.g., events 418, 420, 492, 493, 592, 593). If the UE at block 1404 determines that the UE has no UL resources to transmit the MAC control element, the flow proceeds to block 1408. At block 1408, the UE delays initiation (e.g., transmission) of an SDT resource request for transmitting the MAC control element. That is, the UE refrains from initiating an SDT resource request for transmitting the MAC control element.

Before performing or initiating the SDT session, the UE receives a first message (e.g., RRC release message) including an SDT configuration from the first RAN node or a second RAN node (e.g., the base station 106, DU 174 of the base station 106, or DU 174B of the base station 104) (see e.g., events 332, 334, 394, 432, 434, 494, 495, 594, 595). The UE transitions to or remains in an inactive state in response to the RRC release message or SDT configuration (see e.g., events 336, 402, 436). Then the UE initiates or performs the SDT session with the first RAN node in accordance with the SDT configuration (see e.g., events 404, 492, 493, 592, 593).

In some implementations, the MAC control element (CE) can be a buffer status report (BSR) or a power headroom report (PHR).

In some implementations, the SDT configuration configures one or more SDT radio bearers (RBs). The SDT RB(s) include SDT SRB(s) (e.g., SRB1 and/or SRB2) and/or SDT DRB(s). The RAN node (i.e., the first or second RAN node) configures a particular RB ID for each of the SDT RB(s). For example, the SDT configuration includes an RB list including RB ID(s) of the SDT RB(s). In some implementations, the SDT configuration can include an indication that the SRB2 is suitable for SDT. In such cases, the SDT configuration does not include an RB ID for the SRB2. In some implementations, the SDT configuration includes neither an RB ID for the SRB1 nor an indication that the SRB1 is suitable for SDT. In such cases, the SRB1 can be predefined as an SDT RB by default. In some implementations, the SDT configuration includes a delay configuration. In other implementations, the UE receives a delay configuration in another message (see e.g., events 310, 312, 390).

In yet other implementations, the delay configuration is associated with a MAC control element (e.g., a BSR or a PHR). If the UE detects that the MAC control element is available for transmission, has no UL resources available to transmit the MAC control element, or is configured with the delay configuration, then the UE delays initiation or transmission of the MAC control element.

In some implementations, the delay configuration can be associated with a first SDT RB. In other implementations, the delay configuration can be associated with a first logical channel associating to the first SDT RB. When the UE detects data (associated with the first logical channel or the first SDT RB) available for transmission, the UE at block 1402 determines to send a buffer status report (i.e., a MAC control element) to report a data volume of the data to the RAN node. If the UE has no UL resources for transmitting the buffer status report and is configured with the delay configuration, the UE delays an SDT resource request for requesting UL resources for a predetermined time period. In some implementations, the RAN node can configure the predetermined time period. For example, the RAN node can send a delay timer value specifying the predetermined time period to the UE in the first message. In another example, the RAN node can send a delay timer value specifying the predetermined time period to the UE in a second message (see e.g., events 310, 312, 390). In some implementations, the UE starts a delay timer with the delay timer value, upon or when determining to transmit the buffer status report. While the delay timer is running, the UE refrains from transmitting, to the first RAN node, an SDT resource request for transmitting the buffer status report. After the delay timer expires, the UE can transmit, to the first RAN node, an SDT resource request for transmitting the buffer status report or the data. In some scenarios or implementations, the RAN node does not configure a delay configuration for a (second) SDT RB or a (second) logical channel associating to the second SDT RB. The second SDT RB can be an SDT SRB or an SDT DRB. When the UE detects data (associated with or for the second SDT RB) available for transmission, the UE determines to send a buffer status reporting to report data volume of the data. If the UE has no UL resources for transmitting the buffer status report or the data, the UE transmits an SDT resource request to the first RAN node to request the first RAN node to provide UL resources. In some implementations, the UE can receive, from the RAN node, delay configuration(s) for other logical channel(s) associating with one or more of the other SDT RB(s). In such cases, the UE can apply the delay configuration(s) as described above.

In other implementations, the delay configuration (i.e., a single delay configuration) applies to all SDT RB(s) (e.g., SDT SRB(s) and/or SDT DRB(s)) configured in the SDT configuration. In some implementations, the delay configuration applies to transmission of the MAC control element. When the UE detects data (associated with (one or any of) the SDT radio bearer(s)) available for transmission, the UE determines to send a buffer status report. If the UE has no UL resources for transmission of the buffer status report, the UE delays an SDT resource request for requesting UL resources to transmit the buffer status report for a predetermined time period. In some implementations, the RAN node can configure the predetermined time period. For example, the RAN node can send a delay timer value specifying the predetermined time period to the UE in the first message. In another example, the RAN node can send a delay timer value specifying the predetermined time period to the UE in a second message (see e.g., events 310, 312, 390). In yet another example, the delay timer value can be a default value (e.g., as defined in a 3GPP specification). In some implementations, the UE starts a delay timer with the delay timer value, upon detecting the data available for transmission. While the delay timer is running, the UE refrains from transmitting, to the first RAN node, an SDT resource request for transmitting the buffer status report. After the delay timer expires, the UE can transmit to the first RAN node an SDT resource request for transmitting the buffer status report. In some implementations, the SDT SRB(s) includes SRB0, SRB1 and/or SRB2. In some implementations, the delay configuration does not apply to the SRB0. In such implementations, when the UE in the inactive state has a UL RRC message (e.g., an RRC resume request message) to transmit on the SRB0, the UE can transmit, to the first RAN node, an SDT resource request to transmit the UL RRC message. In other implementations, the delay configuration applies to the SRB0. In such implementations, when the UE in the inactive state has a UL RRC message (e.g., an RRC resume request message) to transmit on the SRB0, the UE delays transmission or initiation of an SDT resource request to the first RAN node. In some implementations, the delay configuration does not apply to the SRB1. In such implementations, when the UE in the inactive state has a UL RRC message (e.g., a non-SDT indication message or a UE assistance information message) to transmit on SRB1, the UE can initiate or transmit an SDT resource request to the first RAN node. In other implementations, the delay configuration applies to the SRB1. In such implementations, when the UE in the inactive state has a UL RRC message (e.g., non-SDT indication message or a UE assistance information message) to transmit on the SRB0, the UE delays transmission or initiation of an SDT resource request to the RAN node.

In cases where the RAN node is a CU (e.g., the CU 172 or CU-CP 172A), the CU generates the SDT configuration (e.g., SDT CU configuration). In some implementations, the CU obtains the delay configuration and/or the delay timer value from a DU. For example, the CU can receive at least one DU-to-CU message including the delay configuration and/or the delay timer value from the DU (see, e.g., events 308, 330, 430).

In cases where the delay configuration is associated with a logical channel, the DU can include a logical channel identity (LCID) of the logical channel in the delay configuration. Alternatively, the DU generates a container IE (e.g., logical channel configuration, a non-SDT DU configuration, an SDT DU configuration, a CG configuration, or a CG-SDT configuration) including the delay configuration and the LCID, and includes the container IE in the DU-to-CU message. The CU can include the container IE and/or the delay timer value in the first message or the second message. In further implementations, the delay configuration includes a bitmap where a bit corresponds to a particular RB ID in the RB list. The DU can set each bit to one of two values (i.e., 0 or 1). One of the two values for a bit in the bitmap (e.g., value 1) indicates that the UE delays an SDT resource request for a corresponding RB ID in the RB list. The other value for the bit (e.g., value 0) indicates that the corresponding RB ID in the RB list indicates that the UE is allowed to transmit an SDT resource request for the corresponding RB ID in the RB list. For example, the RB list includes RB IDs 1, . . . , N, where N is a positive integer. The delay configuration can include a bitmap of bits 1, . . . , N for RB IDs 1, . . . , N respectively. To configure the UE to delay an SDT resource request for transmission of data associated with RB ID X (1<=X<=N), the DU can set the bit X to value 1. Thus, the UE can determine whether to delay transmission or initiation of an SDT resource request for an SDT RB in accordance with a corresponding bit in the bitmap. In cases where the SRB2 is an SDT RB, the DU in some implementations can include, in the DU-to-CU message, a delay configuration for the SRB2. The CU includes the delay configuration specific for the SRB2 in the SDT configuration. Thus, the UE can determine whether to delay transmission or initiation of an SDT resource request for the SRB2 in accordance with the SRB2-specific delay configuration. Alternatively, the DU does not configure a delay configuration for the SRB2.

In other implementations, the CU generates the delay configuration and/or the delay timer value instead of the DU. In cases where the delay configuration is associated with a particular logical channel where a particular SDT RB associates, the CU generate a container IE including the LCID of the logical channel and the delay configuration, and include the container IE in the SDT configuration. In cases where the delay configuration is associated with a particular SDT RB, the CU generates a container IE including an RB ID of the SDT RB and the delay configuration, and include the container IE in the SDT configuration. Alternatively, the CU includes the RB ID of the SDT RB in the delay configuration. In other implementations, the delay configuration includes a bitmap where a bit corresponds to a particular RB ID in the RB list. The CU can set each bit to one of two values (i.e., 0 or 1). One of the two values for a bit in the bitmap indicates that the UE delays an SDT resource request for a corresponding RB ID in the RB list. The other value for the bit indicates that the corresponding RB ID in the RB list indicates that the UE is allowed to transmit an SDT resource request for the corresponding RB ID in the RB list. For example, the RB list includes RB IDs 1, . . . , N, where N is a positive integer. The delay configuration can include a bitmap of bits 1, . . . , N for RB IDs 1, . . . , N respectively. Thus, the UE can determine whether to delay transmission or initiation of an SDT resource request for an SDT RB in accordance with a corresponding bit in the bitmap. In cases where the SRB2 is an SDT RB, the CU can include a delay configuration specific for the SRB2 in the SDT configuration. Thus, the UE can determine whether to delay transmission or initiation of an SDT resource request for the SRB2 in accordance with the SRB2-specific delay configuration. Alternatively, the DU does not configure a delay configuration for the SRB2.

In some implementations, the SDT resource request can be a random access preamble of a four-step random access procedure or a MsgA of a two-step random access procedure. In other implementations, the SDT resource request can be a two-step random access procedure. In such implementations, “transmit an SDT source request” can be replaced with “initiate an SDT resource request”.

After the predetermined time period passes or the delay timer expires, the UE can initiate the four-step random access procedure for transmitting the data associated with the first logical channel or the first SDT RB. In response to the initiation, the UE transmits a random access preamble to the RAN node. In response to the random access preamble, the RAN node transmits to the UE a random access response (RAR) including an uplink grant, a temporary C-RNTI and a timing advance command, and the UE 102 transmits to the RAN node a UL MAC PDU, including the data or a portion of the data, in accordance with the uplink grant. In some implementations, the UE includes a buffer status report and/or a C-RNTI of the UE in the UL MAC PDU. The RAN node receives the UL MAC PDU in accordance with the uplink grant in the RAR. In response to receiving the UL MAC PDU, the RAN node can transmit a DCI on a PDCCH using the C-RNTI. More specifically, the RAN node generates a DCI and a CRC of the DCI, scrambles the CRC with the C-RNTI, and transmits the DCI and scrambled CRC on a PDCCH. After transmitting the UL MAC PDU, the UE monitors a PDCCH using the C-RNTI. When the UE receives the DCI and scrambled CRC on the PDCCH, the UE verifies the scrambled CRC using the DCI and the C-RNTI. If the UE verifies that the CRC is correct, the UE determines that a contention resolution for the four-step random access procedure succeeds.

After the predetermined time period passes or the delay timer expires, the UE can initiate the two-step random access procedure for transmitting the data associated with the first logical channel or the first SDT RB. In response to the initiation, the UE transmits an MsgA including a random access preamble and the UL MAC PDU to the RAN node in accordance with two-step random access configuration parameters. In response to receiving the UL MAC PDU, the RAN node can transmit a DCI on a PDCCH using the C-RNTI. More specifically, the RAN node generates a DCI and a CRC of the DCI, scrambles the CRC with the C-RNTI, and transmits the DCI and scrambled CRC on a PDCCH. After transmitting the UL MAC PDU, the UE attempts to receive a PDCCH using the C-RNTI. When the UE receives the DCI and scrambled CRC, the UE verifies the scrambled CRC using the DCI and the C-RNTI. If the UE verifies that the CRC is correct, the UE determines that a contention resolution for the two-step random access procedure succeeds.

FIG. 14B is a flow diagram of an example method 1400B, similar to the method 1400A, except that method 1400B includes blocks 1407 and 1410. At block 1407, the UE determines whether the UE is configured to delay an SDT resource request. If the UE at block 1407 determines that the UE is configured to delay an SDT resource request, the flow proceeds to block 1408, as described above with regard to FIG. 14A. Otherwise, if the UE at block 1407 determines that the UE is not configured to delay an SDT resource request, the follow proceeds to block 1410. At block 1410, the UE initiates an SDT resource request for transmitting the MAC control element. That is, the UE at block 1410 transmits, to the RAN node (i.e., the first RAN node), an SDT resource request to request that the RAN node schedule UL resources for the UE to transmit the MAC control element.

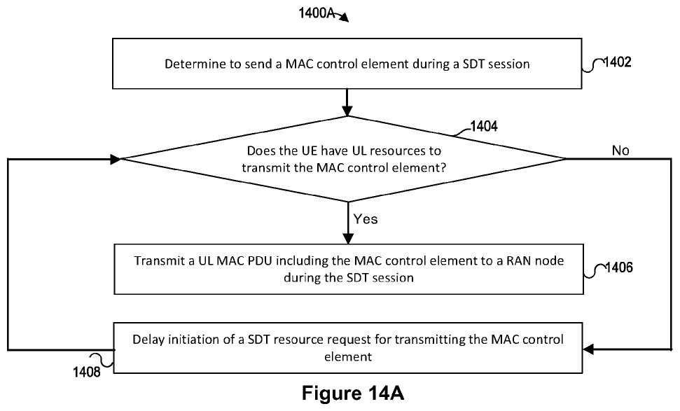

FIG. 15 illustrates a method 1500, which can be implemented by a UE (e.g., the UE 102), for managing data transmission while the UE operates in an inactive state.

The method 1500 begins at block 1502, where the UE receives a delay configuration from a RAN (e.g., the RAN 105, base station 104/106, or DU 174 of the base station 104/106) (see e.g., events 332, 334, 394, 432, 434, 494, 495, 594, 595). At block 1504, the UE applies the delay configuration, while operating in an inactive state (see, e.g., events 418, 420, 492, 493, 592, 593). At block 1506, the UE suspends applying the delay configuration, while operating in a connected state (see, e.g., events 513, 514, 518). That is, the UE refrains from applying the delay configuration, while operating in the connected state.

Examples and implementations described for FIGS. 13A and 14A can apply to the method 1500A. In some implementations, the UE applies the delay configuration as described for FIG. 13A or FIG. 14A. In some implementations, the UE in the inactive state runs a delay timer to delay initiation or transmission of an SDT resource request, and the UE stops the delay timer in response to or after transitioning to the connected state from the inactive state. In some implementations, the delay configuration can be specific for the inactive state or SDT.

In some implementations, the UE releases the delay configuration in response to or after transitioning to the connected state. In other implementations, the UE retains the delay configuration in response to or after transitioning to the connected state. Later on, the UE in the connected state receives an RRC release message transitioning the UE to the inactive state. If the RRC release message does not indicate releasing the delay configuration, the UE can resume to apply the delay configuration after transitioning back to the inactive state from the connected state.

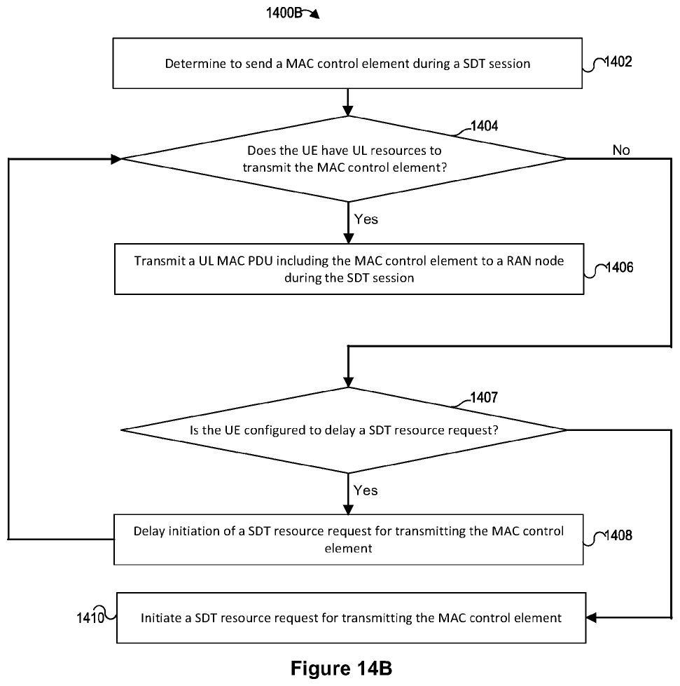

FIG. 16 illustrates a method 1600, which can be implemented by a UE (e.g., the UE 102), for managing data transmission while the UE operates in an inactive state.

The method 1600 begins at block 1602, where the UE receives a delay configuration from a RAN (e.g., the RAN 105, base station 104/106, or DU 174 of the base station 104/106) (see e.g., events 310, 312, 390). At block 1604, the UE applies the delay configuration, while operating in a connected state (see, e.g., events 318, 390, 320, 513, 514, 518). At block 1606, the UE performs SDT with the RAN, while operating in an inactive state (see, e.g., events 418, 420, 492, 493, 592, 593). The flow proceeds to either block 1608 or block 1609. At block 1608, the UE suspends applying the delay configuration during the SDT (see, e.g., events 418, 420, 492, 493, 592, 593). That is, the UE refrains from applying the delay configuration during the SDT. In cases where the delay configuration only applies to the connected state, the UE suspends applying the delay configuration during the SDT. At block 1609, the UE applies the delay configuration during the SDT. In cases where the delay configuration can apply to the connected state and inactive state, the UE applies the delay configuration during the SDT.

In some implementations, the delay configuration is a logicalChannelSR-DelayTimerApplied. The UE at block 1602 can receive a cell group configuration (e.g., CellGroupConfig) from the RAN. The cell group configuration includes an RLC bearer configuration (e.g., RLC-BearerConfig). The RLC bearer configuration includes a logical channel configuration (e.g., a LogicalChannelConfig) which includes the delay configuration and a logical channel identity of a logical channel where the delay configuration applies. The logical channel associates with an RB. When the UE in the connected state detects data (associated with the RB or logical channel) available for transmission, the UE determines to send a buffer status report to report data volume of the data. If the UE has no UL resources for transmission of the data or buffer status report, the UE delays transmission of an SDT resource request for requesting UL resources to transmit the data for a predetermined time period. In some implementations, the UE in the connected state starts a delay timer with a delay timer value to delay the SDT resource request in response to determining to send the buffer status report. While the delay timer is running, the UE refrains from transmitting to or initiating at the RAN a non-SDT resource request for transmitting the buffer status report or the data. After the delay timer expires, the UE in the connected state can initiate or transmit a non-SDT resource request for transmitting the buffer status report or the data. In some implementations, the non-SDT resource request includes a scheduling request procedure, a four-step random access procedure, or a two-step random access procedure. In some implementations, the non-SDT request includes a dedicated scheduling request on PUCCH, a random access preamble of a four-step random access procedure, or an MsgA of a two-step random access procedure.

In some implementations, the UE applies the delay configuration during the SDT as described for FIG. 13A or FIG. 14A.

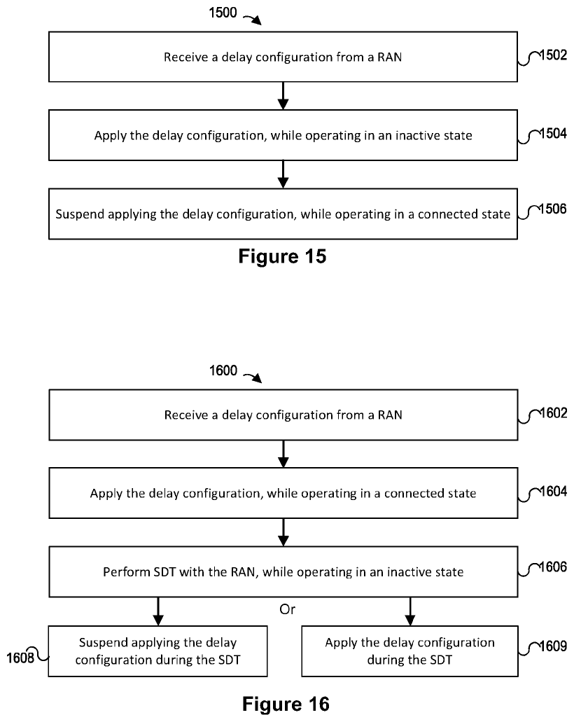

FIG. 17 illustrates a method 1700, which can be implemented by a UE (e.g., the UE 102), for managing data transmission while the UE operates in an inactive state.

The method 1700 begins at block 1702, where the UE receives a delay configuration from a RAN (e.g., the RAN 105, base station 104/106 or DU 174 of the base station 104/106) (see e.g., events 310, 312, 390, 332, 334, 394, 432, 434, 494, 495, 594, 595). At block 1704, the UE determines whether the delay configuration is applicable for a connected state or an inactive state. If the UE at block 1704 determines that the delay configuration is applicable for the connected state, the flow proceeds to block 1706. At block 1706, the UE applies the delay configuration, while operating in a connected state (see, e.g., events 318, 390, 320, 513, 514, 518). In some implementations, the UE in the connected state applies the delay configuration as described for FIG. 9. Otherwise, if the UE at block 1704 determines that the delay configuration is applicable for the inactive state, the UE applies the delay configuration, while operating in the inactive state (see, e.g., events 418, 420, 492, 493, 592, 593). In some implementations, the UE in the inactive state applies the delay configuration as described for FIG. 13A or FIG. 14A.

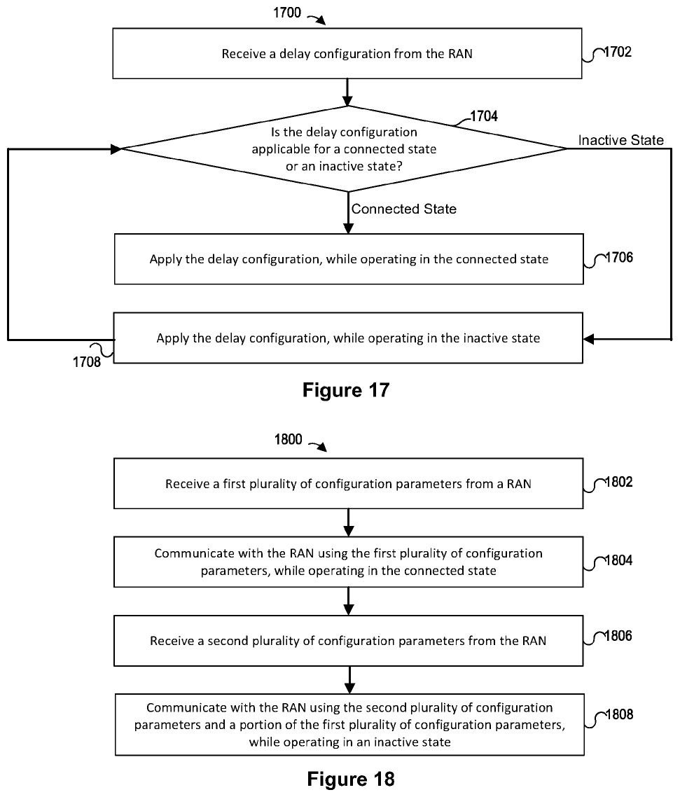

FIG. 18 illustrates a method 1800, which can be implemented by a UE (e.g., the UE 102) for managing data transmission while the UE operates in an inactive state.

The method 1800 begins at block 1802, where the UE receives a first plurality of configuration parameters from a RAN (e.g., the RAN 105, base station 104/106 or DU 174 of the base station 104/106) (see e.g., events 310, 312, 390, 510, 512). At block 1804, the UE communicates with the RAN using the first plurality of configuration parameters, while operating in the connected state (see e.g., events 318, 320, 514, 516, 518). At block 1806, the UE receives a second plurality of configuration parameters from the RAN (see e.g., 332, 334, 394, 432, 434, 494, 495, 594, 595). At block 1808, the UE communicates with the RAN using the second plurality of configuration parameters and a portion of the first plurality of configuration parameters, while operating in an inactive state (see, e.g., events 404, 406, 418, 420, 432, 434, 492, 493, 592, 593).

In some implementations, the UE at block 1802 receives at least one RRC message (e.g., RRC reconfiguration message and/or RRC resume message) including the first plurality of configuration parameters from the RAN. The UE can transmit an RRC reconfiguration complete message to the RAN in response to each of the RRC reconfiguration message(s). For example, the at least one RRC message includes RRC configuration(s), such as cell group configuration(s) (e.g., CellGroupConfig IE(s)), measurement configuration(s) (e.g., MeasConfig IE(s)), and/or radio bearer configuration(s) (e.g., RadioBearerConfig IE(s)), including the first plurality of configuration parameters. The cell group configuration(s) includes RLC bearer configuration(s) including RLC configuration parameters and logical channel configuration(s) (e.g., LogicalChannelConfig IE(s)) for RB(s) configured according to the radio bearer configuration(s). In some implementations, one or more of the logical channel configuration(s) includes a delay configuration (e.g., logicalChannelSR-DelayTimerApplied)

In some implementations, the UE at block 1806 receives at least one RRC release message including the second plurality of configuration parameters from the RAN. In some implementations, each of the at least one RRC release message includes (a portion of) the second plurality of configuration parameters. For example, the at least one RRC release message includes SDT configuration(s) (e.g., SDT-Config IE(s)) including the second plurality of configuration parameters. In some implementations, the SDT configuration(s) include SDT DRB list(s), SDT SRB2 indication(s), SDT-MAC-PHY-Config, SDT-MAC-PHY-CG-Config, an SDT session timer value, and/or an SDT data volume threshold value. In some implementations, the second plurality of configuration parameters may not include a delay configuration. In other implementations, the second plurality of configuration parameters includes a delay configuration as described above.

In some implementations, the portion of the first plurality of configuration parameters includes configuration parameters in the radio bearer configuration(s). In some implementations, the portion of the first plurality of configuration parameters at block 1808 includes configuration parameters in the cell group configuration(s), RLC bearer configuration(s), and/or logical channel configuration(s).

The following description may be applied to the description above.

Generally speaking, description for one of the above figures can apply to another of the above figures. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, “small data transmission” can be replaced by “early data transmission (EDT)” and “SDT” can be replaced by “EDT”, and vice versa. In some implementations, “small data transmission” can be replaced by “small data communication”, and vice versa. In some implementations, “stop” can be replaced by “suspend”.

In some implementations, the “second UE CG-SDT timer” can be replaced by “CG-SDT retransmission timer (cg-SDT-RetransmissionTimer)”. In some implementations, “CG-SDT”, “CG”, “SDT-CG” can be interchanged.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method of transmitting a control element (CE) to a radio access network (RAN), the method implemented in a user equipment (UE) and comprising:
determining, when the UE is performing a small data transmission (SDT) procedure, that a resource for transmitting the CE to the RAN is not available;
receiving, from the RAN, a radio link control (RLC) bearer configuration including a logical channel configuration, the logical channel configuration including a delay configuration; and
delaying, in response to the determining and when the delay configuration applies to the SDT procedure, a transmission of a request for the resource to the RAN in accordance with the delay configuration.

2. The method of claim 1, wherein the delay configuration is specific to a logical channel associated with the SDT procedure.

3. (canceled)

4. The method of claim 1, wherein the logical channel configuration is a LogicalChannelConfig field.

5-8. (canceled)

9. The method of claim 1, wherein the delay configuration includes a logicalChannelSR-DelayTimerApplied indicator.

10. The method of claim 1, further comprising:
determining whether the delay configuration applies to the SDT procedure or a non-SDT procedure.

11. The method of claim 1, wherein the CE is a Medium Access Control (MAC) CE, the MAC CE including a buffer status report (BSR).

12-13. (canceled)

14. The method of claim 1, wherein:
the delay configuration includes a value of a delay timer; and
the delaying includes:
activating the delay timer,
refraining from the transmission of the request for the resource while the delay timer is running, and
transmitting the request for the resource to the RAN after the delay timer expires.

15. (canceled)

16. A method for configuring a user equipment (UE), the method implemented in a radio access node (RAN) and comprising:
generating a delay configuration according to which the UE is to delay requesting a resource for a transmission to the RAN, during a small data transmission (SDT) procedure;
transmitting a radio link control (RLC) bearer configuration, including a logical channel configuration, the logical channel configuration including the delay configuration, to the UE; and
receiving, from the UE and when the delay configuration applies to the SDT procedure, the request for the resource in accordance with the delay configuration.

17. The method of claim 16, wherein the transmitting of the delay configuration is performed when the UE operates in a connected state of a protocol for controlling radio resources between the UE and the RAN.

18. The method of claim 16, wherein the transmitting of the delay configuration includes transmitting a command to reconfigure a radio connection between the UE and the RAN.

19-20. (canceled)

21. The method of claim 16, wherein the generating of the delay configuration includes:
generating a common configuration for the SDT procedure and a non-SDT procedure.

22. The method of claim 16, wherein the generating of the delay configuration includes:
generating a first delay configuration for the SDT procedure, and
generating a second delay configuration for a non-SDT procedure.

23-27. (canceled)

28. The method of claim 16, further comprising:
providing the resource to the UE; and
receiving, from the UE over the resource, a Medium Access Control (MAC) control element (CE) including a buffer status report (BSR).

29-30. (canceled)

31. An apparatus configured to function as a user equipment (UE) and transmit a control element (CE) to a radio access network (RAN), the apparatus comprising:
a transceiver; and
processing hardware configured to:
determine, when the UE is performing a small data transmission (SDT) procedure, that a resource for transmitting the CE to the RAN is not available;
receive, from the RAN, a radio link control (RLC) bearer configuration including a logical channel configuration, the logical channel configuration including a delay configuration; and
delay, in response to determining that the resource is not available and when the delay configuration applies to the SDT procedure, a transmission of a request for the resource to the RAN in accordance with the delay configuration.

32. The apparatus of claim 31, wherein the delay configuration is specific to a logical channel associated with the SDT procedure.

33. The apparatus of claim 31, wherein the logical channel configuration is a LogicalChannelConfig field.

34. The apparatus of claim 31, wherein the delay configuration includes a logicalChannelSR-DelayTimerApplied indicator.

35. The apparatus of claim 31, wherein the processing hardware is further configured to:
determine whether the delay configuration applies to the SDT procedure or a non-SDT procedure.

36. The apparatus of claim 31, wherein the CE is a Medium Access Control (MAC) CE, the MAC CE including a buffer status report (BSR).

37. The apparatus of claim 31, wherein:
the delay configuration includes a value of a delay timer; and
delaying the transmission includes:
activating the delay timer,
refraining from the transmission of the request for the resource while the delay timer is running, and
transmitting the request for the resource to the RAN after the delay timer expires.
